(19) United States
(12) Patent Application Publication
(10) Pub. No.: US 2017/0326777 A1
(43) Pub. Date: Nov. 16, 2017

(54) An Extrusion Tooling for Pipe Extrusion

(71) Applicant: VINIDEX PTY LIMITED, New South Wales (AU)

(72) Inventors: Nicholas Feros, Brisbane (AU); Steven Robert Wood, Toowoomba (AU)

(73) Assignee: VINIDEX PTY LIMITED, New South Wales (AU)

(21) Appl. No.: 15/520,270

(22) PCT Filed: Oct. 20, 2015
(86) PCT No.: PCT/AU2015/050647

§ 371 Date: Apr. 19, 2017

(30) Foreign Application Priority Data
Oct. 20, 2014 (AU) 2014904176

(51) Int. Cl. B29C 47/22; B29C 47/88

(52) U.S. Cl. CPC B29C 47/225; B29C 47/882; B29C 2947/92619; B29C 2947/92904; B29C 2947/92704

(57) ABSTRACT

A flexible die head for continuously extruding pipe may have a flexible ring mandrel (112). A second, open end (120) of the ring mandrel (112) near the die exit may be continuously and resiliently formed to a non-circular shape whilst extruding the pipe so as to provide an extrudate profile to counter slump in plastic pipe forming. Symmetric and asymmetric shapes may be formed by the ring mandrel (112). The second end (120) may be flexed or otherwise distorted by use of a flexing means (122). The ring mandrel (112) may also be necked in a circumferential portion to order to further improve the forming of non-circular shapes.

### BACKGROUND OF THE INVENTION

### 1. Field of the Invention

The present invention relates to a die, mandrel or pin for an extrusion and die heads for extruding pipe. In particular for extruding plastic pipe.

Also in particular the present invention relates to extruding large diameter and thick walled polyethylene pipe. For example plastic pipe of outside diameter greater than approximately 500 mm and wall thickness greater than approximately 60 mm.

### 2. Description of the Art

There are various known arrangements, apparatus and methods for continuously extruding plastic pipes. An extruder containing molten plastic typically supplies molten plastic or “melt” under pressure to an extrusion head that forms the plastic pipe. The extrusion head may have a die head with a circular die used to form the outer surface of the extruded pipe. The die may also be termed a die land or a bush. A co-axial cylindrical mandrel or pin within the die head may be used to form the inner surface of extruded pipe. Typically the pin or mandrel is solid or substantially solid with a fixed geometry. Variable diameter dies or mandrels are typically radially or otherwise segmented to achieve a desired movement. The die with the mandrel or pin together form an annular die gap or channel at the die exit of the extrusion or die head. The extruding plastic forming the pipe exits the extrusion head at the die exit for sizing and cooling. The extrudate pipe formed at the die exit may be sized by sizing or calibration sleeves as described for example in US patent publication numbers 2006/0185183 A1 (Stieglitz) and 2006/0034965 A1 (Ulrich).

Pipe wall uniformity and pipe shape at extrusion may be controlled by adjusting an offset between the mandrel longitudinal axis and the die axis. Thermal centering may also be used to adjust pipe wall uniformity and pipe shape. Thermal centering is where the amount of heating about the extrusion head may be varied to change the flow distribution of the molten plastic through the extrusion head channels to the die exit. The speed of adjustment using thermal centering is dependent on the significant thermal lag present for large die and extrusion heads.

The die and/or the mandrel shape may also be changed by inserting into the extrusion head alternative dies and mandrels with the desired shape. However changing the die or mandrel is undesirable as this requires the extruder to be stopped and the continuous extruding process to be interrupted. Extruding of pipe in the size range of the invention is typically done in a continuous run of one to ten days and a large diameter thick wall pipe as described for the invention may take 5 to 48 hours from start up to stable production with prior techniques. Interruptions to a run reduce production efficiency.

Plastic pipe of polyethylene (PE) may be produced with up to approximately 50 mm wall thickness and up to an approximate outside diameter (o.d.) of 500 mm with a satisfactory circumferential wall uniformity, depending on the output rate of product per hour. However, above this wall thickness for larger pipe diameters sagging of the overall pipe and non-uniformity in the wall thickness may increase to unsatisfactory values for either pipe performance or wastage. Alternatively the production rate may be slowed to the detriment of economical production. Modifiers to the molten plastic may be used to reduce sagging or slumping issues however these modifiers significantly increase materials cost and do not satisfactorily alleviate the sagging or slumping for larger pipe wall thickness and larger pipe outside diameters at the production rates required for economic pipe.

None of these prior art methods, apparatus or devices provides an entirely satisfactory solution to the provision of an extrusion head or a die head for extruding pipe nor to the ease of extruding pipe of a more uniform pipe wall thickness.

Any reference herein to known prior art does not, unless the contrary indication appears, constitute an admission that such prior art is commonly known by those skilled in the art to which the invention relates, at the priority date of this application.

### SUMMARY OF THE INVENTION

The present invention aims to provide an alternative mandrel, pin, die or die head arrangement for an extrusion and a method for extruding which overcomes or ameliorates the disadvantages of the prior art, or at least provides a useful choice.

In one form, the invention provides a flexible die head for extruding pipe comprising: a die gap defined by a mandrel and a die, and a means for flexing at least one of the mandrel and the die; wherein a base of the flexible die head is constrained to a fixed shape; and wherein at least one of the mandrel and the die provides within the die gap a continuous surface for forming a corresponding surface of the extruding pipe.

The mandrel is a flexible ring mandrel.

The flexible ring mandrel comprises: a ring constrained at a first end to a constant shape, a second, opposing end of the ring forming a portion of a die exit, and a wall of the ring between the first end and the second end.

The means for flexing is located within the flexible ring mandrel and is attached to an inner surface of the wall of the flexible ring mandrel.

The flexing means is attached to a rim of the wall and the rim is located proximate the die exit.

The means for flexing deforms the ring mandrel at the die exit to a non-circular shape.

The non-circular shape is at least one of a symmetric ellipse, an asymmetric ellipse, an ovoid, a Cassini oval, a flattened section or chord section of a non-circular shape and an oval.

The flexing means includes an actuator attached to two opposed first mountings to the second end of the ring mandrel.

The flexible die head further includes a quadrilateral arrangement of rods interconnected pivotally at the respective rod ends, wherein a first opposed pivoting rod ends of the quadrilateral are pivotally attached to the first opposed mountings of the ring mandrel, and the second opposed pivoting rod ends of the quadrilateral arrangement are pivotally attached to two further opposed second mountings.

The flexible die head wherein when the actuator extends, the first mountings are outwardly radially displaced and the second mountings are caused to inwardly radially displace; thereby deforming the ring mandrel at the die exit to a non-circular shape.

The flexing means comprises: a first shaft coaxial to the longitudinal axis of the ring mandrel; a pair of opposed shanks, the proximate ends of each shank being pivotally connected to the first shaft and the distal ends of each shank being pivotally connected to two opposed first mountings to the second end of the ring mandrel; wherein the respective proximate end and distal end of each shank are respectively longitudinally offset when pivotably connected to the opposed first mountings and the first shaft such that actuating the first shaft causes the first mountings to outwardly radially displace; thereby deforming the ring mandrel at the die exit to a non-circular shape.

The flexing means further includes: a second shaft coaxial to the longitudinal axis of the ring mandrel; a further pair of opposed shanks, the proximate ends of each further shank being pivotally connected to the second shaft and the distal ends of each further shank being pivotally connected to two opposed second mountings to the second end of the ring mandrel; wherein the respective proximate end and distal end of each further shank are respectively longitudinally offset when pivotably connected to the second mounting and the second shaft such that actuating the second shaft causes the second mountings to inwardly radially displace.

The first and second mountings are respectively diametrically opposed and spaced equidistant about the second end of the ring mandrel such that when the flexing means is actuated a symmetric non-circular shape is formed.

The symmetric non-circular shape of the second end of the ring mandrel includes at least one of a symmetric ellipse, a Cassini oval and an oval.

The first and second mountings are respectively spaced about the second end of the ring mandrel such that when the flexing means is actuated an asymmetric non-circular shape is formed by the second end of the ring mandrel.

The asymmetric non-circular shape of the second end of the ring mandrel includes at least one of an asymmetric ellipse, an ovoid and a flattened section or chord section of a non-circular shape.

The continuous surface includes an outer surface of the wall of the ring.

The outer surface of the wall is continuous from the first end to the second end of the ring mandrel and circumferentially about the ring mandrel.

The continuous surface further includes: the portion of the outer surface of the wall extending from the rim to the first end.

The flexible die head wherein a circumferential portion of the ring mandrel towards the first end is recessed, thereby increasing a flexibility of the second end of the ring mandrel.

The recess is a reduction in a diameter of the circumferential portion of the ring mandrel compared with a diameter of the ring mandrel towards the second end.

The recess is a reduced wall thickness in the circumferential portion compared with a wall thickness in another portion of the ring mandrel towards the second end of the ring mandrel.

The flexible die head wherein a circumferential portion of the ring mandrel towards the first end is increased in a diameter compared with a diameter of the ring mandrel towards the second end, thereby increasing a flexibility of the second end of the ring mandrel.

The flexible die head wherein a displacement between opposed first opposed mountings is up to 32 mm for a ring mandrel diameter up to 540 mm.

The flexible die head wherein a material for the wall of the ring is sufficiently elastic and sufficiently rigid for forming the extruding pipe.

The wall of the ring is formed from concentric, adjacent cylinders.

The number of concentric cylinders is in the approximate range of 2 to 8.

The number of concentric cylinders is in the approximate range of 5 to 8.

The concentric cylinders are secured together at a first end of the ring mandrel.

The second opposed mounting is secured to all the concentric cylinders.

The concentric cylinder material is a steel.

The material is a composite of at least two of a metal, a carbon fibre, a Kevlar fibre and a resin.

The flexible die head wherein the die is a flexible die.

The flexible die head wherein an outside diameter of the extruding pipe is approximately between 500 and 2500 mm.

The flexible die head wherein an outside diameter of the extruding pipe is approximately between 500 and 800 mm.

The flexible die head wherein a wall thickness of the extruding pipe is approximately between 50 and 180 mm.

The flexible die head wherein at least a portion of the material of the extruding pipe is at least one of a plastic, a polyolefin, a polyalkene, a thermoplastic, an extrudable plastic and a polyethylene.

The invention further provides a pipe produced using the flexible die head.

In another form the invention also provides a pipe comprising: an outside diameter greater than approximately 500 mm, a circumferential pipe wall uniformity of less than approximately +/−5 mm for an average wall thickness in the approximate range of 80 to 120 mm, and a material including polyethylene, wherein the pipe was extruded at a rate of at least approximately 800 kg/hour.

In alternate form the invention provides a mandrel comprising: a ring constrained at a first end to a constant shape, a second, partially at least open end of the ring, a wall of the ring between the first end and the second end, and a means for flexing the mandrel.

The means for flexing is located within the mandrel and is attached to an inner surface of the wall of the mandrel towards the second end.

The means for flexing deforms the mandrel at the second end to a non-circular shape.

The mandrel wherein an outer surface of the wall is continuous from the first end to the second end of the ring mandrel and circumferentially about the ring mandrel.

In an alternate form the invention provides a die head for extrusion of pipe, including: an approximately circular, resiliently deformable mandrel ring providing a continuous ring surface for forming an outer or an inner surface of the pipe; and a ring adjustment mechanism for adjusting a circularity of the mandrel ring by resiliently deforming the mandrel ring to adopt a more circular or less circular configuration.

In another form the invention provides a method of extruding pipe including the steps of: providing a continuous and flexible surface in a die head, flexing the continuous surface in the die head whilst continuously extruding the pipe, adjusting the flexing of the continuous surface to form at least one of a non-circular inner surface and a non-circular outer surface of the extruding pipe, and adjusting at least one of the non-circular inner surface and the non-circular outer surface so as to produce a circumferentially uniform wall thickness for the extruded pipe.

The method further including the step of extruding a polyethylene pipe at a rate of at least approximately 800 kg/hour.

The method further including the step of extruding a polyethylene pipe to an outside diameter in the range of approximately 500 to 1200 mm with a circumferential wall uniformity of less than approximately +/−5 mm.

The method further including the step of controlling a cooling of the extruding pipe by varying a suction air cooling from the extruded pipe into the die head.

In another form the invention provides a flexible die head for extruding pipe substantially as herein described.

In yet another form the invention provides a flexible ring mandrel substantially as herein described.

Further forms of the invention are as set out in the appended claims and as apparent from the description.

### DISCLOSURE OF THE INVENTION

### Brief Description of the Drawings

The description is made with reference to the accompanying drawings, of which:

FIG. 1 is a perspective view of a mandrel.

FIG. 2 is an alternate, perspective view of the ring mandrel shown in FIG. 1.

FIG. 3 is a longitudinal cross-sectional schematic of an extrusion head.

FIG. 4 is a front view of the open end of the ring mandrel of FIGS. 1, 2 and 3.

FIGS. 5 and 6 are the same front view of the flexing means and ring mandrel of FIG. 4 but alternatively showing examples of contraction of the actuator.

FIG. 7 is a schematic of a transverse cross-sectional view of a large PE extrudate pipe initially at the die exit.

FIGS. 8A, 8B, 8C, 8D, 9A, 9B, 9C, 9D, 10A, 10B and 10C are technical drawings of another embodiment of the ring mandrel and flexing means.

FIG. 11 is a perspective view of an alternate flexing means.

FIGS. 12 and 13 schematically show two alternatives for hydraulic connections and control to the four hydraulic cylinders or rams of FIG. 11.

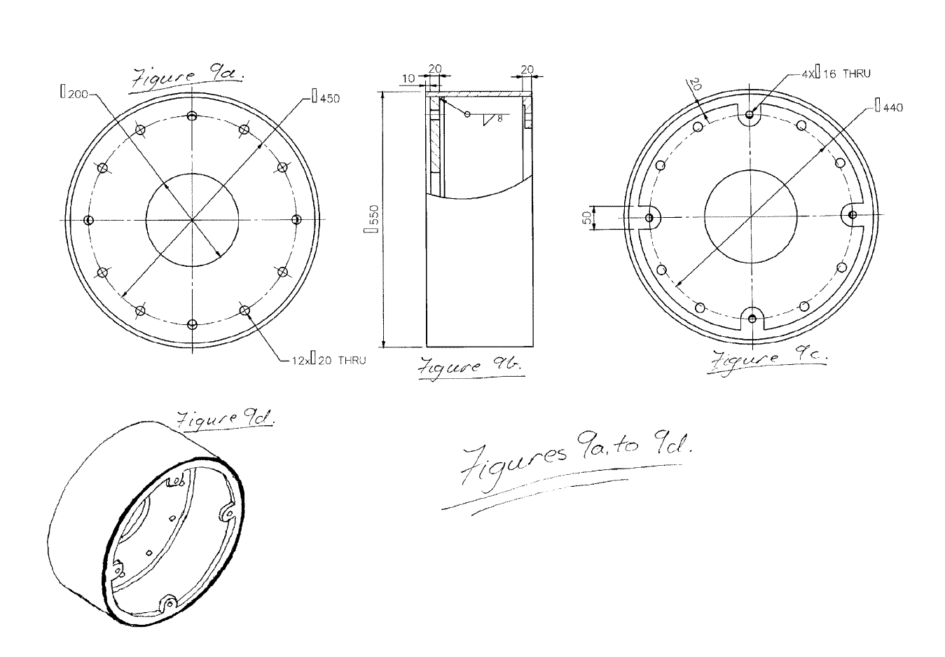

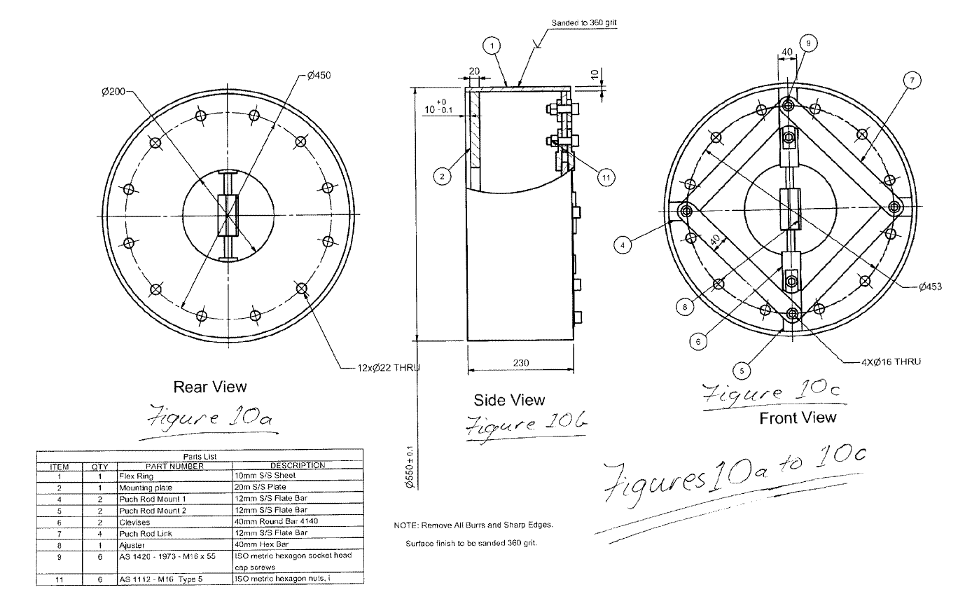

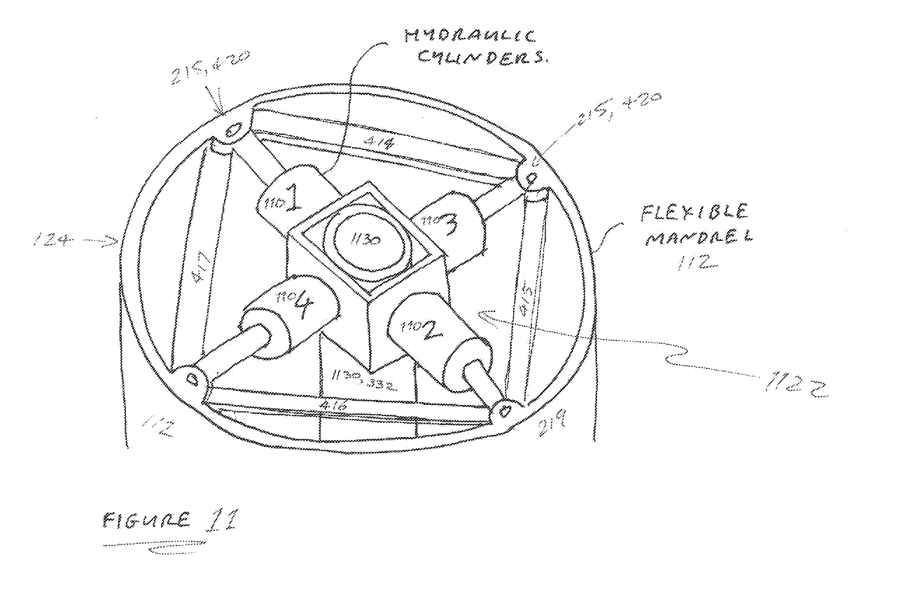

FIGS. 8A, 8B, 8C, 8D, 9A, 9B, 9C, 9D, 10A, 10B and 10C are technical drawings of the alternate flexing means of FIG. 11 together with the ring mandrel.

FIG. 15 is a longitudinal, cross-sectional schematic of an alternate die head with the alternate flexing means of FIG. 11.

FIGS. 16 and 17 are respective perspective and plan views of an alternate ring mandrel.

FIG. 18A is a perspective view of a necked ring mandrel.

FIG. 18B is a longitudinal cross-sectional view of the necked ring mandrel of FIG. 18A.

FIG. 19 is a longitudinal cross-sectional view of an alternative narrowed ring mandrel with a circumferential reduced wall thickness.

FIG. 20 is an alternative or addition to FIG. 18B or 19 where the circumferential portion has an increased diameter compared with the rest of the alternate ring mandrel.

FIG. 21 is a schematic in longitudinal cross-sectional view of a shaft actuated flexing means alternative.

FIG. 22 is a schematic in longitudinal cross-sectional view of a corresponding, independent shaft actuated flexing means to FIG. 21: to inwardly displace the second end wall at second mountings.

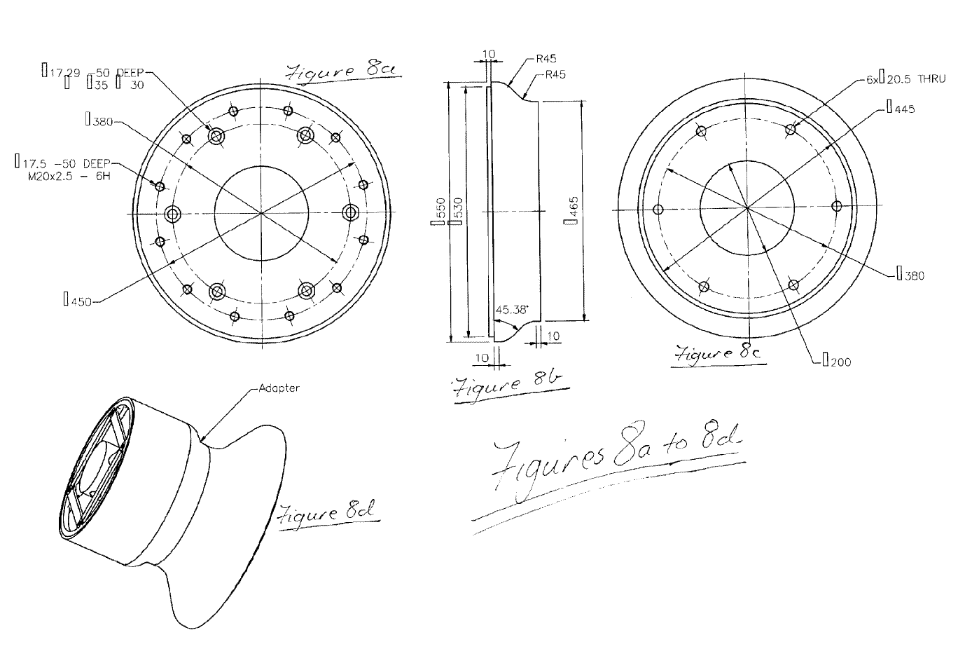

FIG. 23 is a schematic of a transverse cross-sectional view of a large PE extrudate pipe as an asymmetric alternative to FIG. 7.

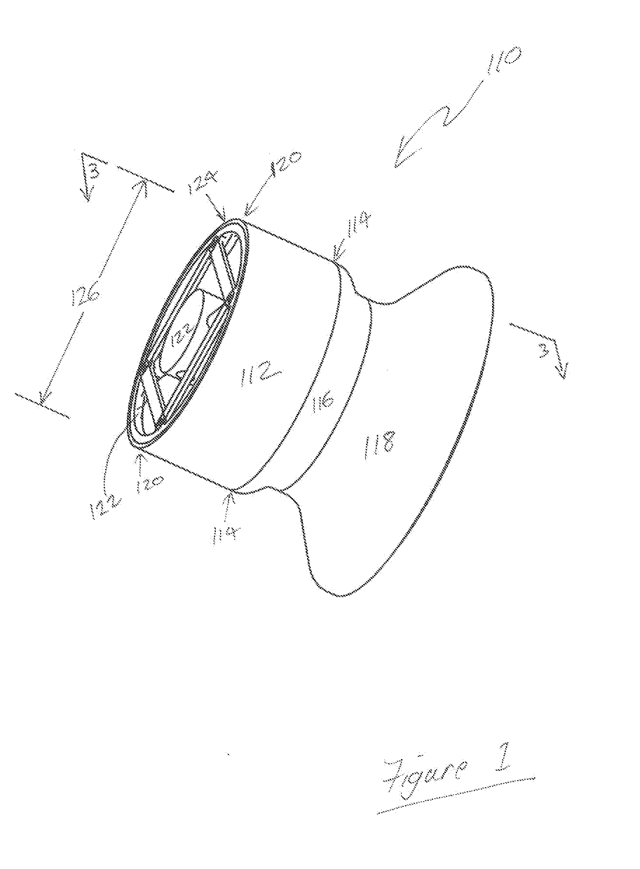

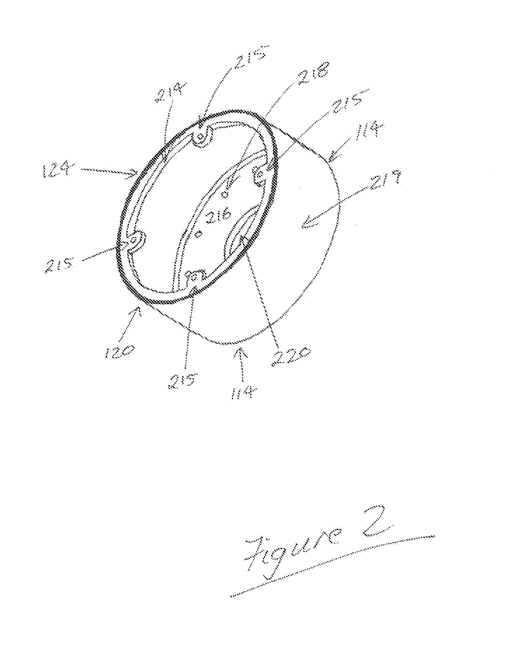

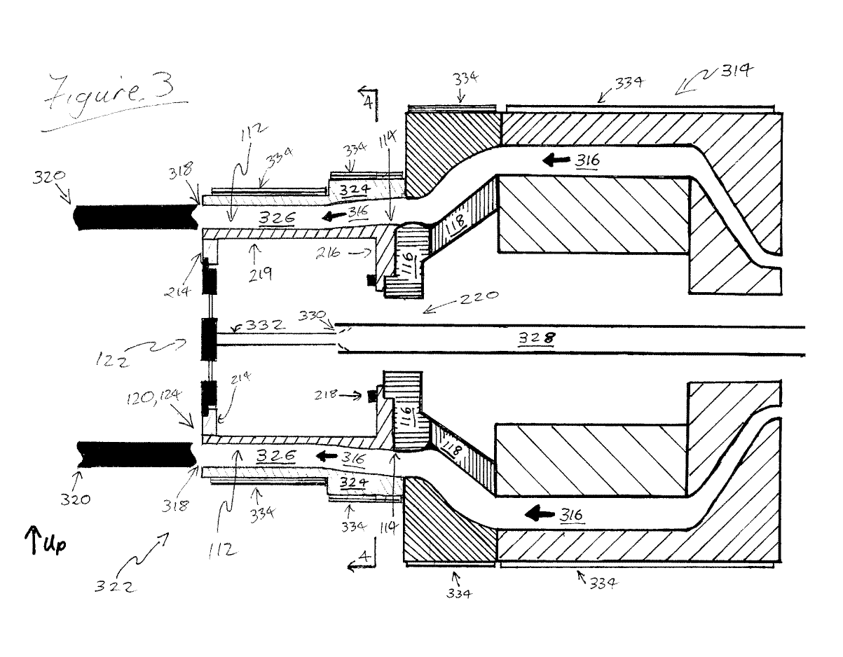

In the figures the reference numerals are prefixed by the figure number. For example FIG. 1 is the “100” series, FIG. 2 is the “200” series and so on.

### DETAILED DESCRIPTION OF THE PREFERRED EMBODIMENTS

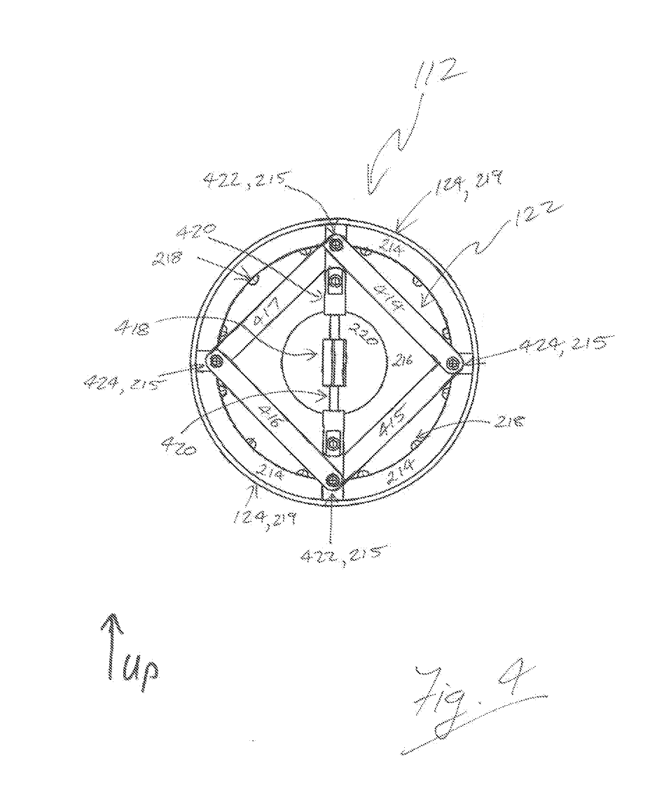

FIG. 1 is a perspective view of a mandrel 110 that may be used in an extrusion head or a die head as described below with respect to FIG. 3. The mandrel 110 has a ring mandrel 112 sub-section which is coupled at a first end 114 of the ring mandrel 112 to an adapter mandrel 116. The adapter mandrel 116 may in turn be coupled to a base mandrel 118 that may secure the overall mandrel 110 to the extrusion head.

At a second, open end 120 of the ring mandrel 112 a flexing means 122 within or proximate to the open end 120 of the ring mandrel 112 acts upon an inner surface of a rim 124 of the ring mandrel 112. The flexing means 122 may be used to distort a circular shape of the rim 124 to another shape by applying radial or other forces to the rim 124. Accordingly the open end 120 of the ring mandrel 112 may also be changed in shape by the flexing means 122.

An outside diameter 126 of the open end 120 of the ring mandrel may be from approximately 300 mm to 1500 mm or up to 2.4 m when used for producing plastic pipe. The large ring mandrel 112 is particularly suited to the extrusion of large diameter pipe. One example of plastic pipe material which may be used with the ring mandrel is polyethylene (PE). An appropriate sized ring mandrel may be used for producing PE pipe of outside diameters in the approximate range from 500 to 2000 mm or up to 2.5 m with wall thicknesses from 50 to 180 mm or up to 200 mm depending on the material required strength (MRS) of the pipe wall More preferably the outside diameter 120 may be approximately 500 to 800 mm for polyethylene pipe with wall thicknesses in the approximate range of 50 to 120 mm. Alternatively the outside diameter of pipe produced with the invention may be in the approximate range of 500 to 1000 mm or in the approximate range of 500 to 1200 mm.

Other plastic pipe types that the invention may also be suitable for are those using or including: a thermoplastic, an extrudable plastic, a polyolefin, a polyalkene, polyethylene varying in density, molecular weight and cross linking. Examples of polyethylene are low density polyethylene (LDPE), linear low density polyethylene (LLDPE) and high density polyethylene (HDPE). Other examples are HDPE materials of types 50, 80, 100 and the like with respective minimum required strengths of 5.0, 8.0 and 10.0 MPa. Examples of extrudable pipe materials are also those being considered as replacements for large diameter ductile iron pipes. It will be readily appreciated that co-extrusion with reinforcing textiles, carbon fibre, Kevlar, metal strands and the like may also be done.

FIG. 2 is an alternate, perspective view of the ring mandrel 112 of FIG. 1. In FIG. 2 the flexing means 122 has been omitted to improve clarity. A mounting inner rim 214 or inner ring for the flexing means 122 is still shown at the open end 120. The mounting inner rim 214 features four rod mountings 215 that provide mounting and pivoting points for the flexing means 122. The four rod mountings are located equidistant about the rim of the open end of the ring mandrel and as two opposed pairs, each rod mounting pair being diametrically opposed across the open end of the ring mandrel. A mounting plate 216 is shown at the first end 114 of the ring mandrel 112. The mounting plate 216 may constrain and maintain the first end 114 of the ring mandrel 112 to a circular shape or configuration. In addition the mounting plate 216 may be used to secure the ring mandrel first end 114 to the adapter 116. A peripheral circular arrangement of bolting or fastener holes 218 in the mounting plate 216 is shown and may be used to secure the ring mandrel 112 to the adapter 116. Securing or constraining the mounting plate 216 and the first end 114 to the adapter 116 and then to the mandrel base 118 further constrains the mounting plate 216 and the first end 114 of the ring mandrel to be planar. It will be readily appreciated that a person skilled in the art may select other fastening and securing techniques for the first end 114, the mounting plate 216 and the adapter 116. For example welding may be used in combination with suitable fasteners.

The arrangement of the mounting plate, the first end of the ring mandrel and the adapter stiffens and makes suitably rigid the first end of the ring mandrel so that it remains suitably planar and circular in order to function as described further below. The ring mandrel wall 219 between the open end rim 124 and the constrained first end 114 will vary in its rigidity and flexibility according to the distance from the first end. That is the first end of the ring mandrel is maintained in a fixed shape that is circular and planar

A services port 220 is shown in the centre of the mounting plate 216. The services port 220 may provide access for a suction air service which is described with respect to FIG. 3 and further below. The services port 220 may also provide access for services to drive and/or control the operation of the flexing means 122. For example mechanical linkages, pneumatic lines and/or an electrical supply.

FIG. 3 is a longitudinal cross-sectional schematic of an extrusion head 314. An extruder (not shown) supplies molten plastic or “melt” to multiple channels 316 of the extrusion head 314. Arrows 316 of the channels 316 indicate the direction of the melt through the channels 316 of the extrusion head 314 to the die gap 326 and out the die exit 318. The arrows 316 are shown as solid headed arrows. The melt from the die exit 318 forms the cooling extrudate pipe 320. Extrusion heads 314 for large pipe diameters typically have channels 316 with various structures, pinches and other elements within or about the channels to homogenise the melt as well as to vary the melt flow about the extrusion head to aid in providing an appropriate flow of melt to the die head 322 for pipe formation.

A die head 322 of the extrusion head 314 has the mandrel 110 centred in a cylindrical or conical die 324. The open end 120 and rim 124 of the ring mandrel 112 is approximately co-planar with the die exit 318 end of the die 324. The annular channel 316 between the ring mandrel 112 and the die 324 forms an annular die gap 326.

The extrudate pipe 320 from the die exit 318 of the extrusion head may then pass through a calibration or sizing sleeve (not shown) at an entry to a vacuum cooling tank of water (not shown). Calibration or sizing sleeves are often constructed of multiple curved segments as described for example in US patent publication numbers 2006/0185183 A1 (Stieglitz) and 2006/0034965 A1 (Ulrich). Such multiple discontinuous segments may be applied to the outer surface of the cooling extrudate pipe 320 as by then the outer surface has sufficiently skinned and/or hardened such that the outer surface is not appreciably affected by the discontinuous segments of the calibration or sizing sleeves. Typically the calibration or sizing sleeves are configured to provide a circular aperture for the pipe and may also aid in imposing a circular shape to the pipe outer as it cools.

The inside of the pipe 320 within the vacuum cooling tank may be at atmospheric pressure as this may aid in maintaining the shape of the pipe as it cools within the vacuum cooling tank. Ultrasonic thickness gauges may be used within the vacuum cooling tank to monitor pipe wall thickness about the circumference of the pipe.

After cooling a haul-off tractor or puller (not shown) may be applied to the pipe to move the pipe as well as an aid in controlling and maintaining a back thrust to the forward thrust from the extruder through the extrusion head. After the haul-off tractor the pipe may be either coiled or cut to length depending on the pipe product and outside diameter. Large diameter pipe of typically greater than 500 mm outside diameter is usually cut to length.

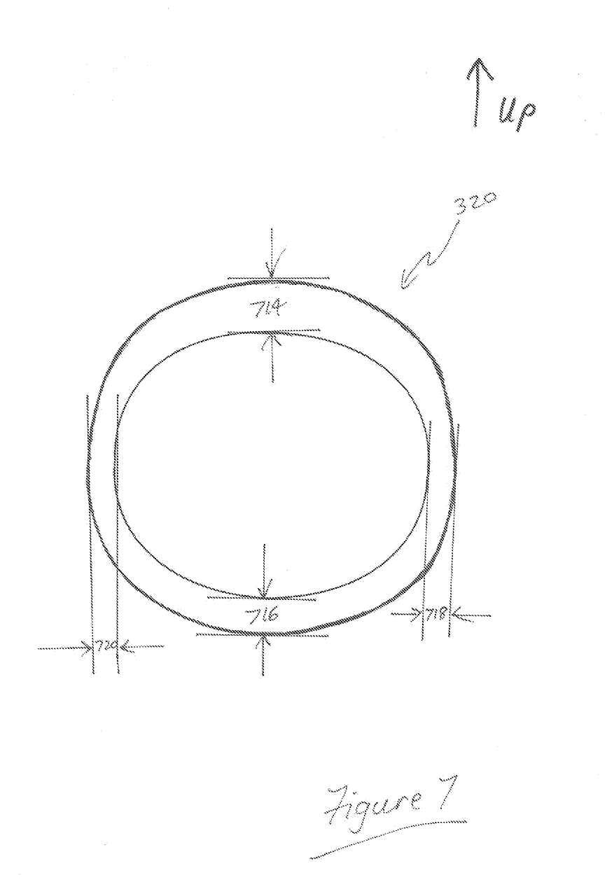

FIG. 3 also shows a services conduit 328 longitudinally through the extrusion head 314. The services conduit 328 provides a suction air service 330 as described above with respect to FIG. 2 and further after FIG. 6. The suction air service 330 draws ambient air from the extrudate pipe end into the extruding pipe and the inside of the ring mandrel. An alternate suction air service conduit or tube is described below with respect to FIGS. 11 and 15. The services conduit 328 may also provide the drive and/or control 332 for the flexing means as described above with respect to FIG. 2. Heater bands and plates 334 may be applied to the extrusion head 314 and die head 322 in order to maintain the extrusion head at a temperature suitable for forming pipe. The arrangement of the heater bands and plates 334 and the temperatures maintained about the extrusion head 314 may be configured and selected to thermally adjust the flow of melt 316 forming the pipe. In one example the temperatures about the extrusion head for forming polyethylene pipe (PE) may be in the approximate range of 170° to 220° C. or as further described below after FIG. 6.

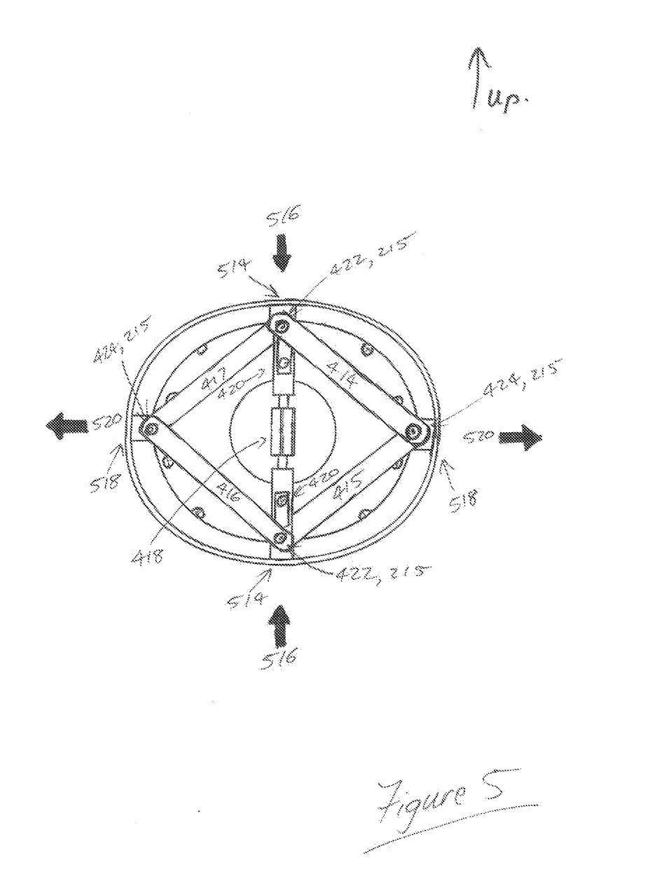

FIG. 4 is a front view of the open end 120 of the ring mandrel 112. FIG. 4 also shows a front view of the flexing means 122 attached to the rod mountings 215 of the inner rim mounting 214. The flexing means 122 in FIG. 4 is shown in the resting or neutral position such that the rim 124 of the open end 120 of the ring mandrel is substantially circular due to the resilience of the materials used for the inner rim mounting 214 and the ring mandrel 112. For example a suitable steel, spring steel and/or stainless steel alloy material may be selected together with suitable dimensions for the inner rim mounting and 214 and ring mandrel 112 to provide the necessary resilience. The wall 219 of the ring mandrel for example may have a thickness of approximately 10 mm whilst the mounting plate 216 at the first end of the ring mandrel may have a thickness of approximately 20 mm. FIGS. 8A, 8B, 8C, 8D, 9A, 9B, 9C, 9D, 10A, 10B and 10C provide technical drawings with dimensions of one example of a suitable ring mandrel together with an adapter and base mandrel. It will be readily appreciated that a person skilled in the art may select the materials and thicknesses of the components for the ring mandrel and flexing means to be suitable for the functioning and the purposes described herein. For example the wall 219 and rim 124 of the ring mandrel must have the necessary or sufficient resilience/stiffness/elastically deformability to function as a flexible ring mandrel but also to be able to support the melt flow under pressure within the die gap 322. Alternatively the additional, inserted rim 124 may be optional, with the wall 219 being sufficient to support the member mountings 215. Other forms of the rim are described further below.

The flexing means 122 has an arrangement of four rods or linkage members 414, 415, 416, 417 that are interconnected at their ends to form a square arrangement in the neutral position of the flexing means 122. The rods are approximately equal in length in order to form the square, quadrilateral arrangement and to correspond to the equidistant rod mountings 215 about the rim or open end of the ring mandrel. The linkage members are pivotally connected at their respective ends to the rod/member mountings 215 as shown in FIG. 4 as well as each other in the square arrangement. At a centre of the square arrangement 414, 415, 416, 417 an adjuster, actuator 418 or adjustment mechanism is located. The actuator 418 has two ends 420 or devises which connect to opposing rod mountings 422, 215 which may be referred to here as the first rod mountings 422. The other, second opposed rod mountings 424 are not connected to the actuator 418 but are connected to the other ends of the rods that are connected to the actuator ends 420.

The actuator 418 operates to either extend or contract the distance between the opposed first mountings 422, 215. The extension or contraction of the actuator 418 and the corresponding actuator ends 420 may be achieved by the actuator ends as threaded rods into an appropriately threaded sleeve of the centrally located actuator 418. The threaded rod ends being left and right hand threads respectively so that when the actuator sleeve rotates either way the threaded rod ends move appropriately to achieve the required extension or contraction between the first rod mountings 422, 215. The sleeve of the actuator 418 may be driven to rotate as may be readily designed and constructed by a person skilled in the art. For example an electric motor winding coaxial with a magnetised sleeve or otherwise. It will be readily appreciated that other means for extension and contraction by the actuator may be used, for example a pneumatic arrangement, a hydraulic arrangement, a geared arrangement driven by the flexing means drive 332, piezoelectric actuators and the like. An alternate flexing means with a hydraulic cylinder or ram arrangement is described below with respect to FIGS. 11 to 15.

It will be readily appreciated that whilst the inner mounting rim, rod mountings and adjuster are shown mounted substantially at the open end of the ring mandrel for greatest, practical mechanical advantage; they may also be located at a distance from the open end and still perform the same function of deforming the ring mandrel. A person skilled in the art may select a suitable position depending on constraints that may be imposed by particular extrusion heads and the like.

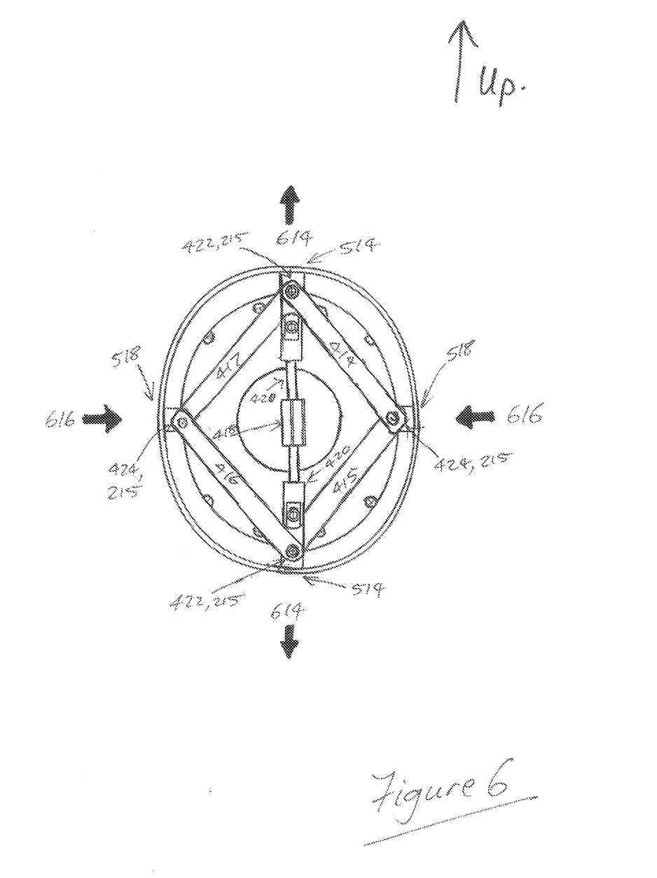

FIGS. 5 and 6 are the same front view of the flexing means and ring mandrel of FIG. 4 but alternatively showing examples of contraction of the actuator 418, FIG. 5, and expansion of the actuator 418, FIG. 6. In FIG. 5 the contraction of the actuator 418 pulls together the first rod mountings 422 with the corresponding rim portions 514 of the open end of the ring mandrel as shown by the solid arrows 514. That is the first rod mountings are inwardly, radially displaced. The contraction of the actuator 418 also causes the other ends of the rods 414, 415, 416, 417 not connected to the actuator ends to push outwardly, radially upon the second rod mountings 424 and the other corresponding rim portions 518 in the direction of solid arrows 520. The contraction of the actuator 418 may cause the rim of the ring mandrel to be “ovalised” into the shape of a symmetric ellipse with a minor axis between the first rod mountings 422 and a major axis between the second rod mountings 424. Similarly the square arrangement of the interconnected rod or linkage members 414, 415, 416, 417 is now a quadrilateral with corresponding minor and major axes to the rim 124.

In FIG. 6 the actuator 418, 420 extends in the direction of the solid arrows 614 so that the first rod mountings 422 and the opposing rim portions 514 move radially outwards. In a similar manner as described for FIG. 5 the second rod mountings 424 are caused to move towards each other radially as shown by the other solid arrows 616. The major axis of the ring mandrel ellipse at the open end 120 is now between the first rod mountings 422 and corresponding rim portions 514. The minor axis of the ellipse is now between the second rod mountings 424 and their corresponding rim portions 518. Similarly for the quadrilateral arrangement of the rods or member linkages 414, 415, 416, 417.

It will be readily appreciate that when it is desired to regain the circularity of the rim 124 from an ellipsoidal shape that the resilience of the open end of the ring mandrel and the inner rim mounting 214 may be used to aid in regaining the circularity as well as use of the actuator 418. The inactive or neutral state of the actuator may also correspond to a circular rim of open end due to the resilience of the materials used for the ring mandrel 112 and/or the inner rim mounting 214.

In the example of forming PE pipe of diameter in the approximate outside diameter range of 500 to 600 mm with wall thickness in the approximate range of 90 to 110 mm: the range of movement or displacement radially for each of the major and minor axes of the rim 124 of the open end of the ring mandrel may be up to approximately 10 to 20 mm or more as required. The range of movement and the shape of the consequent ellipse formed at the die exit for the mandrel or pin is discussed further below with respect to the forming of pipe.

It will be readily appreciated that the actuator or adjuster 418 may be mounted horizontally rather than vertically, that is rotated ninety degrees with respect to FIG. 4 and still produce the same effect. In another form the rods or member linkages may also be omitted but the actuator retained to adjust the circularity of the rim 124 to an ellipse. The use of the rods 414, 415, 416, 417 with corresponding rod mountings 215 may provide more precise forming of symmetric ellipses than may be possible without the rods. Other forms of the flexing means may include those to impart asymmetric deformation or asymmetric shapes for the rim 124 of the open end of the ring mandrel are discussed in detail further below.

It will also be readily appreciated that inner rim mounting 214 may be optional. The rod mountings 215, 422, 424 for the rods and the actuator ends may be mounted directly to the inner surface of the rim 124 of the open end 120 of the ring mandrel 112. Alternatively or additionally a partial inner rim mounting segment (not shown) may also be attached to the wall 219 with the rod mounting in order spread the loads applied by the rod mounting to the wall 219 and/or the rim 124. The partial ring mounting segment may also be used to adjust or limit the deformation of the wall 219 or rim 124 of the ring mandrel. The use of the inner rim mounting 214 may improve the resilience of the rim 124 for restoring circularity and also for forming a symmetric ellipse; however the particular requirements for forming large pipe with thick walls may not require the additional performance of the inner rim mounting 214. In another form the lack of an inner rim mounting 214 and the use of only the actuator without the rods 414, 415, 416, 417 may also be used if the combined additional performance of these features is not required.

The ring mandrel 112 with the flexing means 122 may be used as described above with respect to FIGS. 4 to 6 within the extrusion head 314 and in particular the die head 322. The fixed and constrained first end 114 of the ring mandrel 112 to the adapter 116 and base 118 mandrels is maintained in a circular and planar configuration within the extrusion head. When the actuator 418 of the flexing means 122 is extended or contracted the rim 124 may be resiliently or elastically deformed out of circularity and consequently the ring mandrel wall 219 is also deformed out of circularity. The amount of change in cross-sectional shape of the wall 219 from circularity to elliptical for the wall will depend on the distance from the constrained first end 114. Advantageously the deformation in the wall 219 is smooth and continuous resulting in a change in the annular die gap 326 inner and outer surfaces respectively of the deformed ring mandrel wall 219 and the die land 324 which is also smooth and regular so as to not introduce any defects in the extrudate wall internally or upon the pipe's inner or outer surfaces. That is the wall forms a continuous surface when it is deformed as well as when it is not deformed. That is a smooth continuous surface is provided by the outer surface of the wall from the first end to the second end of the ring mandrel as well as circumferentially about the ring mandrel. In addition the rim may also form a continuous surface when it is deformed as well as when it is not deformed. Consequently the annular die gap 326 width will smoothly and continuously vary depending on the location about the annular die gap space 326 and the depth into the annular die gap space 326 from the die exit 318.

An alternate flexing means is described below with respect to FIGS. 21 and 22 for the ring mandrels described herein.

It will be readily appreciated that the form and use of the adapter and base mandrel sections described above with respect to FIGS. 1 to 3 is by way of example only. For the performance of the invention the adapter and/or the base mandrels aid in additionally constraining the ring mandrel first end with the mounting plate 216. The form of the adapter and base mandrel may also be changed or adapted by a person skilled in the art so as to be suitable for joining the ring mandrel to other extrusion heads and to have a suitable form or profile for the melt channel or channels. In addition the adapter and base mandrels may also be modified or substituted so as to extend and improve the function of the ring mandrel, as described below with respect to FIGS. 18A, 18B, 19 and 20.

In the following description the o'clock (or polar co-ordinate) convention for the front view of the ring mandrel of FIG. 4 will be used to reference locations about the wall of the ring mandrel. For example in FIG. 5 the arrow marked “up” provides the orientation of features with respect to ground and the force of gravity. The top or uppermost first rod mounting 422 corresponds to the 12 o'clock position, the opposing first rod mounting at the bottom is the 6 o'clock position. Similarly for the second rod mountings 424, the right and left mountings are respectively the 3 and 9 o'clock positions. It will also be readily appreciated that showing the direction of ‘up’ on the other FIGURES of 3 to 7 is also useful as the sag and slumping experienced by the extrudate pipe 320 is attributable to the force of gravity acting upon the pipe material whilst cooling.

When the ring mandrel/pin 112 in the state or position of FIG. 5 is used in the extrusion head of FIG. 3 the annular die gap spaces 326 at the 3 and 9 o'clock positions are reduced most at the die exit 318. From the die exit 318, the die gap at the 3 and 9 o'clock positions increases with distance from the die exit 318 to a maximum gap at the first end 114 of the ring mandrel 112. Conversely in comparison at the 12 and 6 o'clock positions of the die exit 318: the die gap 326 is increased. From the die exit 318 to the first end 114, the die gap 326 decreases to a minimum at the 12 and 6 o'clock positions.

The FIG. 5 state, operating position or configuration of the elliptical ring mandrel may divert at least a portion of the melt flow from the 3 and 9 o'clock portions of the annular die gap 326 and preferentially to the upper and lower portions of the annular die gap that respectively correspond to the 12 and 6 o'clock positions. The resultant extrudate pipe from the die exit may have a wall thickness profile which is thinner at the 3 and 9 o'clock positions or wall portions and thicker in the 12 o'clock position or wall portion. The sag or slump of wall material from the thicker 12 o'clock portions of the upper pipe wall to the thinner walls at the 3 and 9 o'clock wall portions may be calculated and/or determined to provide improved pipe wall uniformity as the extrudate pipe cools.

In addition offsetting the centre of the ring mandrel 112 to be lower than the centre of the die 324 may increase the die gap 326 at the 12 o'clock position compared with or relative to the 6 o'clock lower die gap space. Accordingly melt may preferentially flow to the upper portion of the annular die gap 326 so as to initially form an extrudate pipe 320 at the die exit 318 with initially a thicker pipe wall at the 12 o'clock position relative to the lower 6 o'clock pipe wall position. The initial increase in material at the 12 o'clock pipe wall portion compared with the 6 o'clock wall portion may also be calculated and/or determined so that sag and/or slump of pipe wall material downwards results in a more uniform pipe wall for the cooling extrudate pipe.

In addition or alternatively thermal centering may also be used to increase the amount of melt flowing at the 12 o'clock die gap space 326 compared with the lower 6 o'clock die gap space. This may also result in an initial extrudate pipe with an initially thicker pipe wall thickness at the 12 o'clock position compared with the lower 6 o'clock pipe wall portion. In the example for PE pipe of outside diameter approximately 500 to 800 mm and approximate wall thickness 90 to 110 mm, example temperatures about the die head 322 may be approximately 210° C. at approximately the 12 o'clock position, approximately 170° to 180° C. at approximately the 3 and 9 o'clock positions and approximately 200° C. at approximately the 6 o'clock position. In this example lower relative temperatures at the 3 and 9 o'clock positions about the die head 322 may reduce the flow of melt in those die gap spaces compared with the hotter die gap spaces at 12 o'clock and to a lesser extent at the lower 6 o'clock die gap space. In another example the pipe may have an outside diameter of 800 mm with a SDR of 7.4 and wall thickness of approximately 108 mm. In a further example the pipe may have an outside diameter of 1000 mm and a wall thickness of approximately 92 mm.

In addition to thermal centering provided by external heating 334 of the die head 322 and/or extrusion head 314, adjusting the suction air cooling via the suction air service 330 to the extrudate pipe 320 and the wall 219 of the ring mandrel may be used. Ambient air drawn to the inside of the extrudate pipe at die exit aids in cooling the inner surface of the pipe wall as the pipe further forms a uniform pipe wall thickness about the pipe as well as circular inner and outer walls of the pipe transverse cross-section. Too aggressive cooling may result in defects and/or holes to the inside wall of the extrudate pipe forming.

Cooling of the wall 219 of the ring mandrel 112 and/or rim 124 may also result from the suction air cooling service of FIG. 3. The amount of suction air cooling flow rate for the extrudate pipe and the ring mandrel may be adjusted diurnally and seasonally in the range of a factor of approximately five to twenty times of the maximum flow rate depending on the ambient air temperature and the temperature of the die head 322. For example maximum flow rate cooling may be applied at about midday on a summer's day of 30° C. ambient air temperature whilst a minimum flow rate of approximately 5% of the maximum air flow rate (of 100%) may be used for a winter's morning of 0° C. Diurnally the flow rate at dawn may be approximately 20% to 30% of the suction air flow rate used at midday for the example PE pipe of outside diameter approximately 500 to 600 mm. Alternatively, a thermostatically controlled pre-heater for the ambient air drawn into the extrudate pipe end may be used so as to reduce the amount of adjustment required for the suction air cooling flow rate.

In addition or alternatively an asymmetric rim and ring mandrel deformation may be used to provide the desired flow of melt in the die gap spaces with respect to the 3, 6, 9, 12 and other o'clock positions. In particular the use of non-symmetric ellipsoidal ring mandrel deformation shapes may reduce or eliminate how much centre offset and/thermal centering is required. Asymmetric ring mandrel deformation and control is described in detail further below.

FIG. 7 is a schematic of a transverse cross-sectional view of a large PE extrudate pipe initially at the die exit 318, as an example of what may be produced by the methods and apparatus of the above. FIG. 7 is not to scale and is exaggerated in proportions for illustrative purposes. A pipe wall thickness 714 at the 12 o'clock position is thicker than the pipe wall thickness 716 at the lower 6 o'clock position and the side wall thicknesses 718, 720 at the 3 and 9 o'clock positions. The initial and relative side wall thicknesses 718, 720, to the 12 o'clock position and/or 6 o'clock position, may be calculated and/or otherwise determined to account for sag, slumping or otherwise flow of pipe wall material from the upper portion of the pipe at approximately the 12 o'clock position to the side walls at approximately the 3 and 9 o'clock positions for the extrudate pipe 320 as it is cooling.

It will be readily appreciated that the calculation and/or determination of the initial extruded pipe wall thicknesses about the pipe may be in the form of a manual and/or automatic feedback control loop of a continuously operated pipe extrusion line. The ring mandrel as a flexible ring mandrel may be continuously adjusted in shape during extrusion and pipe forming to provide improved pipe wall thickness uniformity about the pipe. Adjustments to pipe wall uniformity using the flexible ring mandrel may be made considerably faster than thermal methods which have a thermal lag. In addition it may be easier to adjust pipe wall uniformity using the single control of the flexing means with expansion or contraction of the adjuster to the ring mandrel than the multiple screw or bolt adjustments necessary for adjusting mandrel or pin centre offset to the die centre.

An example of automatic feedback control may be the use of feedback from a circumferential array of ultrasonic thickness gauges or sensors in the vacuum cooling tank providing control signals to the flexing means adjuster/actuator 418.

It is typical that each prior art surface of the die gap formed or defined by prior art mandrels and dies are a constant or fixed in shape for forming large diameter pipe of outside diameter greater than approximately 500 mm. That is typically prior art mandrels and dies have no joints or moveable surface segments for such large diameter pipe forming. At the die head 322 the surfaces defining the annular die gap 326 should be continuous or free of discontinuities or joints, free of retractable elements or segments so that melt flow is laminar and free of disturbances which may develop into defects in the extrudate pipe wall surface as well as in the thickness of the pipe wall. In addition those prior art mandrels and dies of prior art die heads are typically solid thick walled pieces or tools greater than 40 mm thick for forming pipe outside diameters of up to 1200 mm so that the prior art mandrel may provide the necessary rigidity and thermal inertia for extruding large diameter, thick walled plastic pipe. Whereas the wall 219 of the flexible ring 112 may have a thickness of 20 mm or less and as described herein. The flexible ring mandrel 112 and flexing means 122 described here is not constructed nor functions in the manner of such prior art mandrels. The flexible ring mandrel may be changed in shape during the extrusion and pipe forming process without interrupting the process line. To change shape for prior art mandrels it would be necessary to stop the process line and then change the mandrel or pin for another with a different shape. The changing of the shape of the die gap at the die head using the flexible ring mandrel reduces or eliminates the need for changing mandrels or pins and thus also improves productivity with reduced downtime for the process line.

The improvements in production of PE pipe in the example of outside diameter approximately 500 to 1000 mm are multiple. An improved circumferential pipe wall uniformity specification of less than +/−5 mm for a pipe wall average thickness in the approximate range of 80 to 120 mm. More preferably the pipe wall average thickness may be in the approximate range of 90 to 100 mm for polyethylene pipe of an outside diameter in the approximate range of 500 to 700 mm. Improved pipe wall uniformity also benefits in reduced material wastage since the Material Required Strength (MRS) minimum pipe wall thickness tolerance is improved; 1 to 2% reductions in PE materials wastage by a higher specification for pipe wall uniformity are economically significant. The improved specification to pipe wall uniformity may still be attained with a high production or extrusion rate of approximately in the range of 800 to 1300 kg/hour or at least 800 kg/hour or more. Prior art mandrels may also produce a high pipe wall uniformity specification but at a dramatically reduced production rate which may be approximately ten times lower. For example use of prior art mandrels may only be used at approximately 10 mm/hour or 60 kg/hour. Such low production rates for prior art mandrels are not economic for large diameter, approximately 600 mm o.d., PE pipe.

The flexible ring mandrel 112 provides a flexible die head 322 for the extrusion and pipe forming of extrudate pipe 320. A flexible die or flexible bush (not shown) about the flexible ring mandrel may also be used to contribute to the functioning and performance of the flexible die head 322.

A flexible ring mandrel for a flexible die head that can form asymmetric shapes for the rim at the open end of the ring mandrel may offer advantages in reducing the need for using centre offsets between the die and mandrel centres and/or thermal centering or otherwise thermal manipulation of melt flow through the die head to form an appropriate initial extrudate pipe such as in FIG. 7. For example it may be desirable to deform the ring mandrel to form a more ovoid planar shape at the rim that has only one axis of symmetry about the major, vertical axis. That is an asymmetry is introduced about the minor, horizontal axis.

An example of an ovoid shape would be a side view of an egg. The ring mandrel may be deformed such that the base of the ovoid is lowermost and the major axis is vertical. This may result in an initial extrudate pipe with thicker walls at approximately the 1 to 2 o'clock position and at the 10 and 11 o'clock position which will supply pipe wall material through sagging, slumping or otherwise to the initially thinner side walls of the cooling extrudate pipe. Alternatively a more complex shape for the rim and ring mandrel may be desirable for example a combination of elliptical, ovoid, Cassini ovals, flattened sections or chords to improve control of pipe forming for the initial extrudate pipe.

In the following a number of examples are given of different configurations of the flexing means and the ring mandrel to provide different shape control of the ring mandrel. Further examples of alternate flexing means and ring mandrels are described below with respect to FIGS. 16 to 22.

For the example of a planar ovoid shape, this may be achieved by a different arrangement of the rod members, rod mountings and actuator to that described above for FIG. 4. For example a quadrilateral arrangement of four rods may be used where the first rod mountings are located as two diametrically opposed mountings at 12 o'clock and 6 o'clock upon the inner surface of the rim as before for FIGS. 2 and 4. The other two rod mountings may then be offset such that they are located at approximately 4 o'clock and 8 o'clock instead of 3 and 9 o'clock. Corresponding rod lengths may be then be used to provide the quadrilateral arrangement, for example the lower rods 415, 416 of FIG. 4 would be shorter in length than the upper rods 414, 417. The actuator 418 may still be connected to the diametrically opposed rod mountings 422. Extension and contraction of the actuator may result in a deformation of the rim of the ring mandrel which may be more ovoid or oval shape.

Alternatively or additionally the resilience of the inner mounting ring 214 and/or the rim 124 may be adjusted so that the positions between 1 and 2 o'clock and 10 and 11 o'clock of the inner mounting ring and/or rim are less resilient. This may be achieved by using a thinner inner mounting ring portion in those positions and/or a thinner rim and wall thickness in those positions. Alternatively the inner rim mounting 214 may be notched in some portions of the rim mounting so that it is less resilient or less stiff in those portions.

Another alternative would be to provide a flexing means with a pentagonal arrangement of rods and rod mountings to the rim of the ring mandrel. The adjuster could be connected to a rod mounting and the mid-point of an opposing rod.

FIG. 23 is a schematic of a transverse cross-sectional view of a large PE extrudate pipe 2320 initially at the die exit 318, as an example of what may be produced by the methods and apparatus of the above for asymmetric shape forming. In the manner of FIG. 7, FIG. 23 is not to scale and is exaggerated in proportions for illustrative purposes. A ring mandrel used to form the asymmetric shape of FIG. 23 may have a flexing means with additional actuators and mountings at the 7:30 o'clock and 4:30 o'clock positions at the second end of the ring mandrel so as to provide the minimum wall thickness positions at the corresponding 7:30 o'clock 2322 and 4:30 o'clock 2324 positions of the extrudate pipe 2320 from the die exit. Such an asymmetric shape forming, with continuous, feedback adjustment during pipe forming may provide superior pipe wall uniformity specifications.

Other ring mandrel shape forming options may be obtained by connecting the actuator ends to the rim directly at a suitable mounting without an arrangement of rods about the rim of the open end of the ring mandrel. The actuator ends could be attached to the rim at diametrically opposed positions or at chordal positions on the rim as required. The chordal positions may be selected such that the adjuster and actuator do not intersect the centre of the ring mandrel in its neutral position. Similarly multiple chordal adjusters may be attached about the rim or otherwise of the ring mandrel to provide a desired shape changing flexibility.

In another form only one actuator end may be attached to a single suitable mounting on the rim of the ring mandrel. The other actuator end may be suitably connected or anchored to suitable point within the extrusion head. For example a suitable point may be at the base of the mandrel or further towards the extruder end of the extrusion head. Such an arrangement of the flexing means may be useful for providing a flat spot to the otherwise circular shape of the rim of the ring mandrel.

It will be readily appreciated for the above examples that the ring mandrel in its neutral or rest position need not be constructed circular or cylindrical. The ring mandrel may be pre-formed or fabricated into an intermediate shape to what it may be deformed into during use. For example for the elliptical form of FIG. 5 a ring mandrel may be constructed with a rim which is intermediate between an ellipse and a circle. The wall of such a preformed elliptical ring mandrel may transition from the ellipse of the rim to the circular shape of the first end of the ring mandrel which is attached to the extrusion head. Such pre-formed ring mandrel shaping may improve the dynamic range of extension and contraction of the actuator to enable more suitable annular die gap formation of a flexible die head.

The ability to form asymmetric extrudate pipe may be useful for applications where it is desired to have a controlled asymmetry to pipe wall thickness. For example plastic pipe use in river or estuary dredging may desirably have a thicker pipe wall at the base wall of the pipe which is dragged along the river or estuary bottom. A thicker base of the pipe wall allows for an additional wear component to the wall thickness before the critical MRS wall thickness is reached. An asymmetric forming, flexible ring mandrel may be used to form such asymmetric wall profiles by adjusting the elliptical or otherwise cross sectional and orientation of the ring mandrel to give the wall thickness required for the extruded pipe.

In another example: billets or pipe sections to be used for swept bends. An outer spine of the pipe bend may be made thicker in anticipation of operational/in use thinning of the pipe wall of the swept bend.

FIGS. 8A, 8B, 8C, 8D, 9A, 9B, 9C, 9D, 10A, 10B and 10C are technical drawings of another embodiment of the ring mandrel and flexing means. The technical drawings include dimensions to many of the features. It will be readily appreciated that many of the aspects within the drawings are also applicable to other forms of the invention described herein. For example the aspect ratios described with respect to FIGS. 18A, 18B, 19 and 20. Examples of the adapter mandrel and the base mandrel are also shown in FIGS. 8A, 8B, 8C and 8D.

FIG. 11 is a perspective view of an alternate flexing means 1122 for deforming the wall 219 of the ring mandrel 112. In FIG. 11 four hydraulic cylinders or rams 1101, 1102, 1103, 1104 may be used rather than the single adjuster or actuator 418 shown in FIG. 4. FIG. 11 also shows an alternate suction air service conduit 1130 which extends through the alternate flexing means 1122 as shown. The alternate suction air service 1130 may extend beyond the die exit 318 and into the extruded pipe as shown below with respect to FIG. 15.

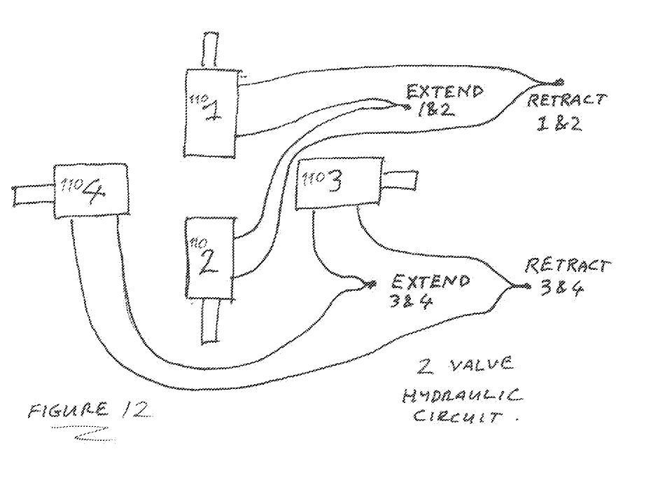

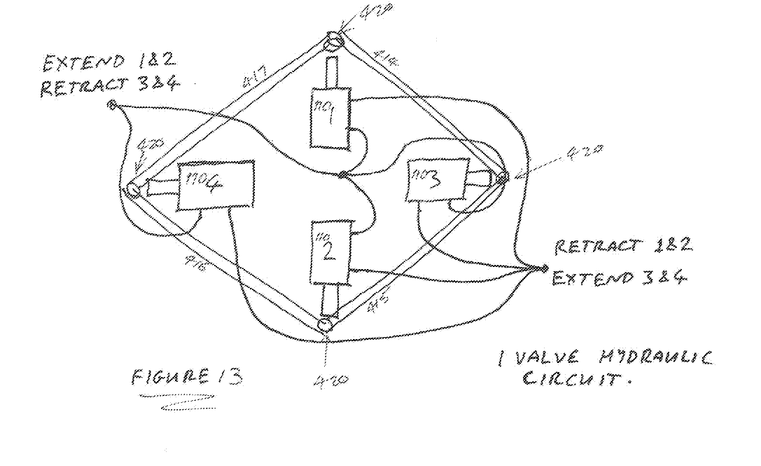

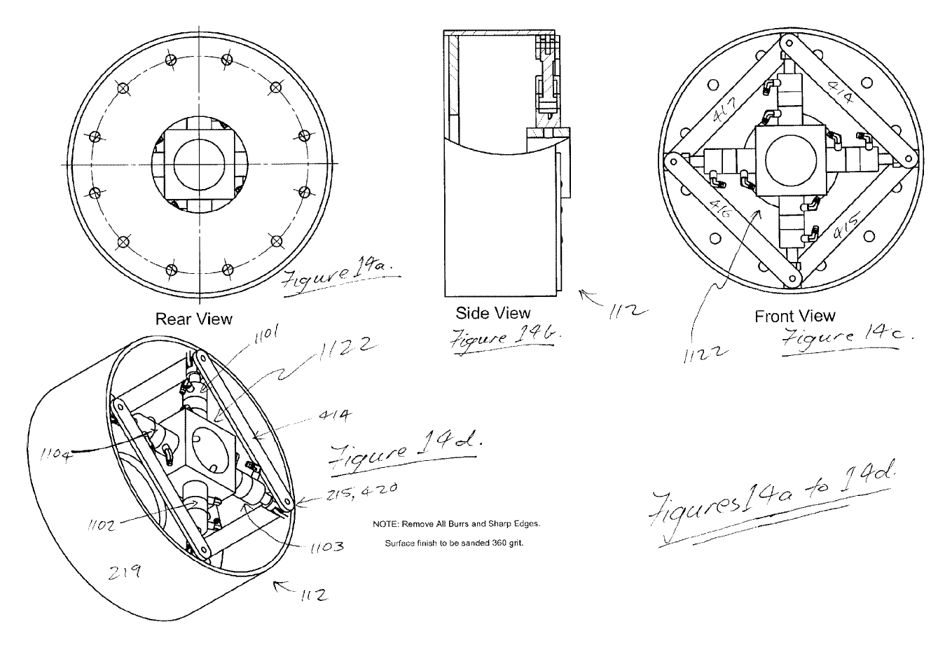

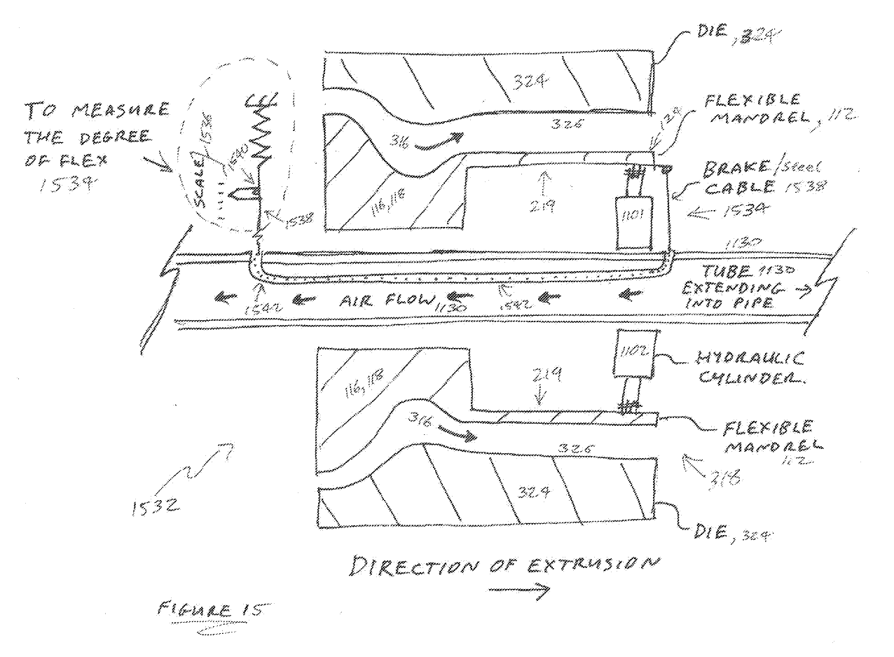

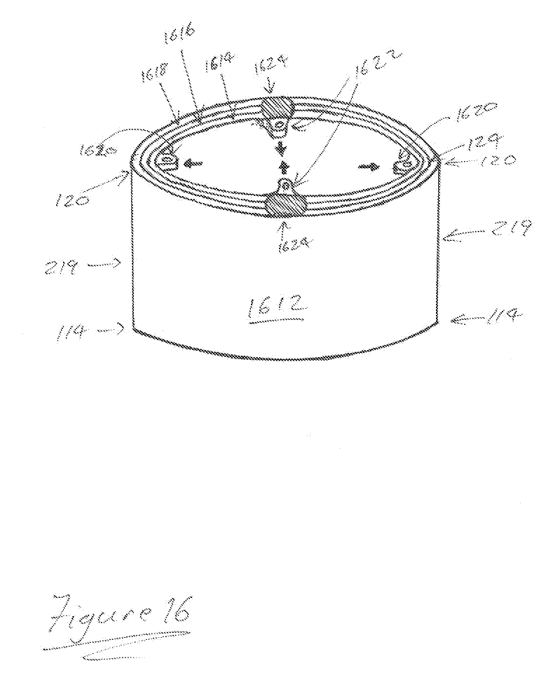

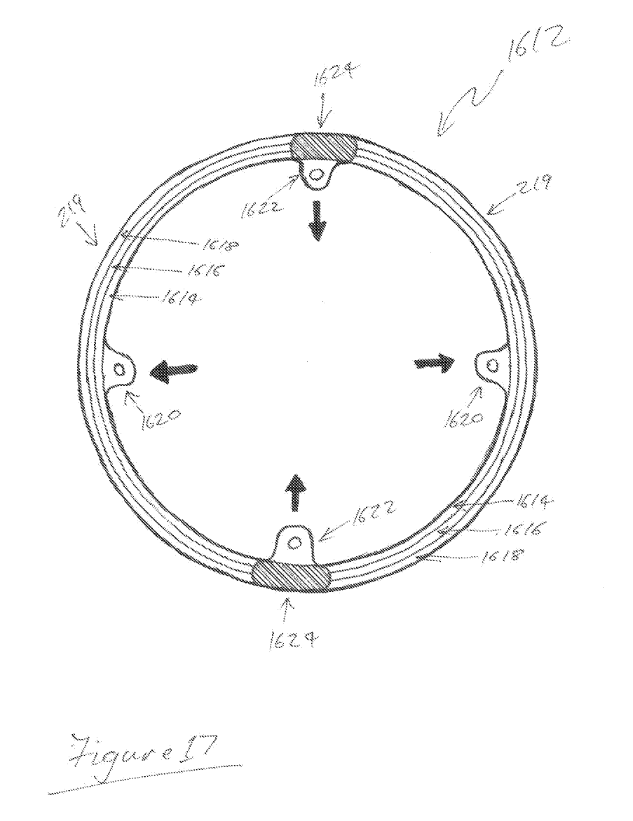

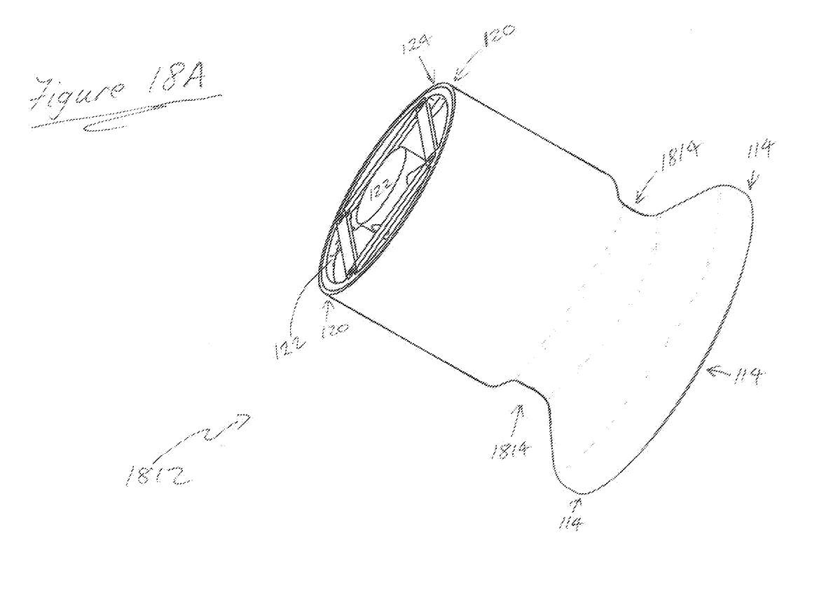

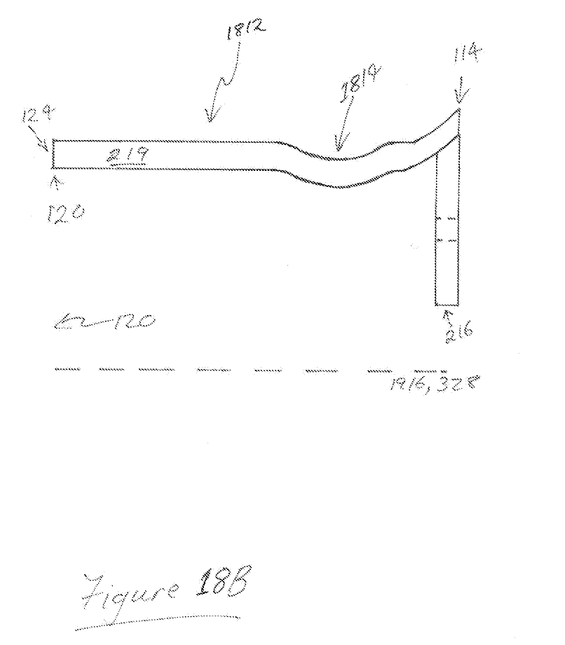

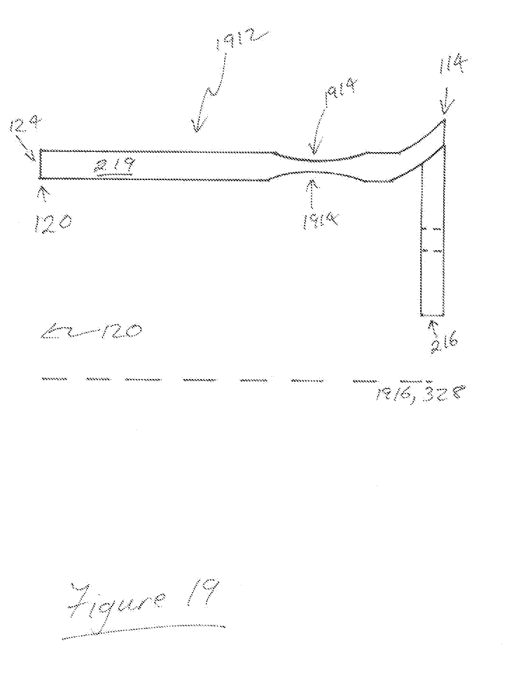

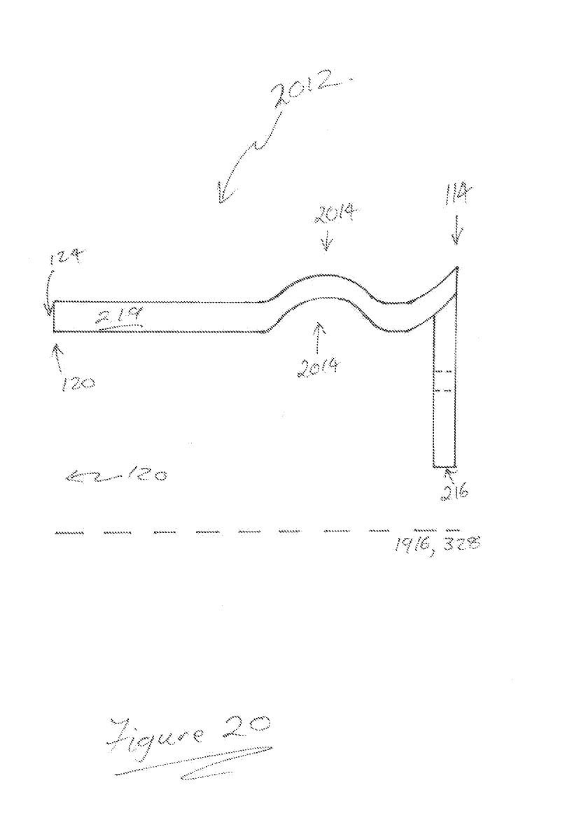

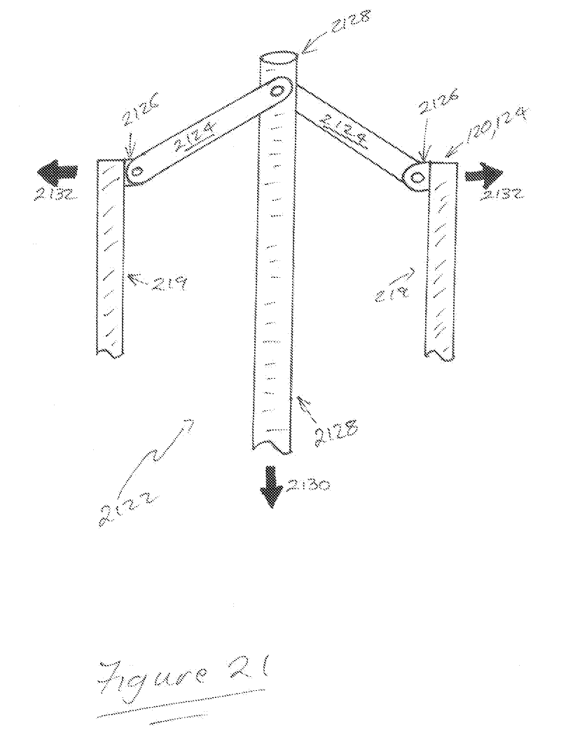

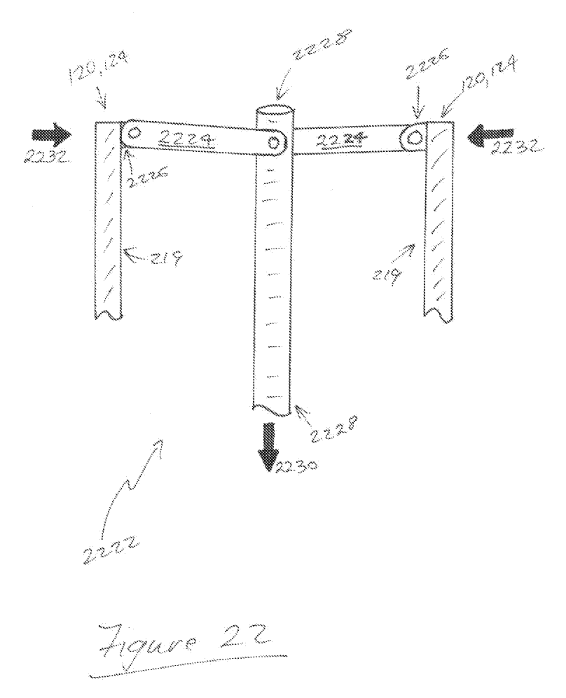

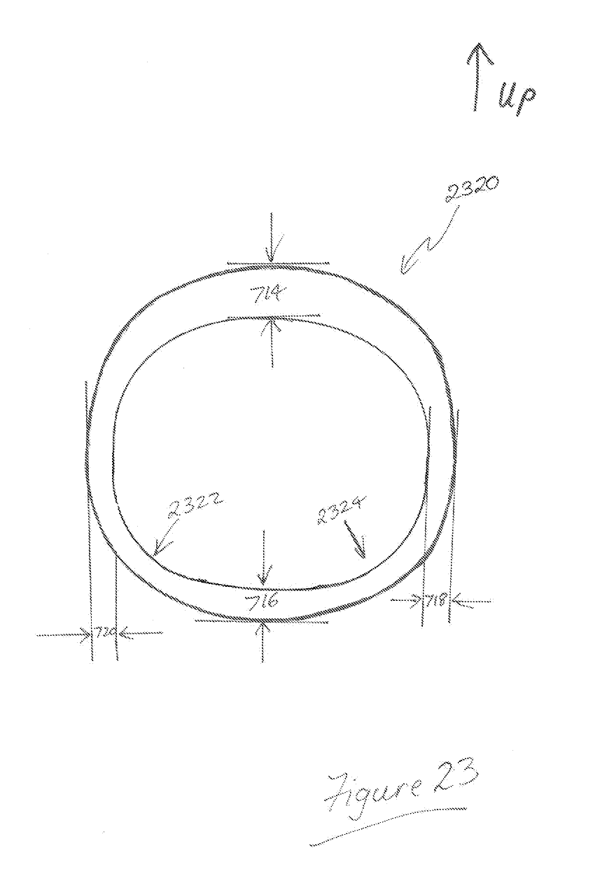

FIGS. 12 and 13 schematically show two alternatives for hydraulic connections and control to the four hydraulic cylinders or rams 1101, 1102, 1103, 1104 of FIG. 11. The hydraulic cylinders may be hydraulically connected in a paired arrangement as shown in FIGS. 12 and 13. Accordingly in a paired arrangement opposed hydraulic cylinders 1101, 1102 may extend whilst the orthogonal hydraulic cylinders 1103, 1104 may retract in order to deform the ring mandrel as shown in FIG. 6. Similarly opposed hydraulic cylinders 1101, 1102 may retract whilst the orthogonal hydraulic cylinders 1103, 1104 may extend in order to deform the ring mandrel as shown in FIG. 5.

FIG. 12 shows a hydraulic control circuit using two valves. FIG. 13 shows a hydraulic circuit utilising only one valve. It will be readily appreciated that a person skilled in the art of hydraulic control and mechanics may select the hydraulic cylinders, control line arrangements, valving, hydraulic pressures and the like in order produce the forces from the hydraulic cylinders necessary to deform the ring mandrel appropriately when used in a die head. For example for FIG. 12 each pair of hydraulic cylinders should be substantially identical in performance in order to balance the resultant force and ring mandrel deflection for the single applied hydraulic pressure used.

For FIG. 13 the cylinders may be actuated as a full set of four, such that hydraulic cylinders 1101 and 1102 are extended whilst hydraulic cylinders 1103 and 1104 are retracted. Similarly for FIG. 13, hydraulic cylinders 1101 and 1102 are retracted when hydraulic cylinders 1103 and 1104 are extended. In FIG. 13 the four hydraulic cylinders 1101 and 1102 may be substantially identical in performance if a single hydraulic pressure is used. However it may be found advantageous in operation of the flexing means 1122 for the ring mandrel within the die head that the hydraulic cylinders 1103 and 1104 are a different size to the other paired hydraulic cylinders 1101 and 1102 in order to balance the required forces and deflection for the ring mandrel to produce a flow of the melt 316 and desired annular die gap 326 circumferential profile from the same applied hydraulic pressure to all four hydraulic cylinders 1101, 1102, 1103, 1104. Different sized hydraulic cylinder pairs may be particularly advantageous for producing asymmetric ring mandrel deformations as described herein.

FIGS. 14A, 14B, 14C and 14D are technical drawings of the alternate flexing means 1122 of FIG. 11 together with the ring mandrel 112.

It be readily appreciated that the flexing means described herein may also be secured to a rigid post or other rigid arrangement from the extrusion head along a longitudinal axis within the ring mandrel. Such an additional securing of the ring mandrel may be used to maintain a centred or off-centred position for the second end of the ring mandrel during the use of the flexing means.

FIG. 15 is a longitudinal cross-sectional schematic of an alternate die head 1532 with the alternate flexing means 1122. The schematic of FIG. 15 is a similar view of the die head as shown for FIG. 3. A position sensing device 1534 or position sensing means may be co-located with the flexing means 122, 1122 to provide an indication 1536 of the amount of radial displacement of the rim 124 or otherwise wall 219 portion of the ring mandrel. In the example shown in FIG. 15 a steel cable 1538 may be attached at one end to the rim 124 of the ring mandrel at a rim position where the amount of radial displacement of a rim portion, a rod mounting or an actuator for example is desired to be known or indicated. The other end 1540 of the steel cable 1538 may be attached to an indicator scale 1536 that is located at a convenient location about the exterior of the extrusion head. The cable 1538 may be sheathed 1542 as appropriate for routing within the die head and extrusion head to the exterior. Alternatively the position sensing means may utilise the volume displaced of hydraulic fluid of a hydraulic cylinder 1101, 1102, 1103, 1104 or the movement of a piston within a hydraulic cylinder.

FIGS. 16 and 17 are respective perspective and plan views of an alternate ring mandrel 1612. The alternate ring mandrel may have a wall 219 constructed of multiple layers or laminations of a suitable metal such as steel. Alternatively the laminated ring mandrel may be constructed of concentric, adjacent cylinders of steel that are sleeved one inside of the other. In FIGS. 16 and 17 three layers or laminations are shown of an inner cylinder 1614, a middle cylinder 1616 and an outer cylinder 1618. In the example shown three laminations are present however two to eight or more laminations or cylinders may be used or more preferably from five to eight laminations.

The dimensions of the laminations or cylinders 1614, 1616, 1618 may be chosen so as to provide an interference fit, with the tightness of the fit being chosen according to the desired level of slip between the cylinders to provide satisfactory flexibility and resilience. Alternatively the laminated ring mandrel 1612 may be constructed from two “C” sections, each with the desired number of layers of sheet metal shaped together into a “C” section, then to be joined together at the ends to form the laminated ring mandrel 1612. The two “C” sections may be welded together to form the laminated ring mandrel 1612.

At the first end 114 of the laminated ring mandrel 1612 the laminations may be welded together or otherwise secured in order to be rigidly secured to the extrusion head via the adapter mandrel or otherwise. The die exit end of the second end 120 may have unsecured laminations in order to improve the flexibility and resilience for non-circular shape forming of the alternate ring mandrel 1612.

The flexing means may be used to move or displace the second end or die exit end of the alternate ring mandrel as described herein. The first mountings 1620 which are outwardly displaced need only be secured to the inner cylinder 1614. The second mountings 1622 which are inwardly displaced by the flexing means however are more desirably secured to all the laminations 1614, 1616, 1618 so that the outer surface of the wall 219 at the second mountings 1622 is displaced appropriately. Accordingly the second mountings 1622 may have their respective bases welded through the laminations so that the inwardly applied force from the flexing means acts across all the laminations. The welded zone 1624 or otherwise securing from the base through all the laminations is shown in FIGS. 16 and 17.

In addition or alternatively the wall 219 may also be constructed of a composite. For example the inner and outer layers may be metal cylinders, as described above, which sandwich a composite material of carbon fibre and resin. It will be readily appreciated that any composite material selected for use may be selected as appropriate for the temperatures and stresses relevant to this application. In addition the materials may be selected so as to not affect or otherwise detrimentally interact with the extrusion and forming of the pipe product. The use of a composite wall of varying materials of suitable thickness may allow for superior flexibility, resilience and shape forming characteristics of the ring mandrel.

FIG. 18A is a perspective view of a necked ring mandrel 1812. A circumferential necking 1814 of the mandrel wall 219 towards a first end 114 of the necked ring mandrel may allow for further flexibility and resilience of the second end 120 at the die exit. The necking, diameter narrowing or otherwise formation of a circumferential recess 1814 in the ring mandrel wall profile between the first end and the second end may improve the ease and dynamic range of displacement to produce non-circular shape profiles. The necking may partially isolate the flexing or movement at the second end 120 from the rigid first end of the necked ring mandrel. In addition, excessive stresses to the rim 124 of the wall 219 may be substantially reduced such that possible fatigue splitting of the rim and mandrel wall does not occur. The necked ring mandrel 1812 in addition may have no internal support structures apart from a suitable mounting plate or the like at the first end 114 of FIG. 18A so as to rigidly secure the mandrel to the extrusion head, see FIGS. 18B, 19 and 20. FIG. 18B is a longitudinal cross-sectional view of the necked ring mandrel 1812 showing circumferential necked portion 1814 in cross-section.

The ring mandrel 114 described with respect to FIG. 1 and further may be modified or substituted to be a necked ring mandrel 1812. The modification may include the ring mandrel extending to the extrusion head attachment point and with the former sections to the adapter mandrel 116 and base mandrel 118 being replaced by the necked ring mandrel 1812 circumferential portion 1814 to the first end 114 of the necked ring mandrel. Accordingly it will be readily appreciated that such structures as the mounting plate 216 would be relocated in the necked ring mandrel, to the corresponding first end 114 to attach to the extrusion head mounting fixtures as shown in FIG. 3.

Alternatively or in addition to a necking of the ring mandrel wall, the circumferential recess may be formed by narrowing the mandrel wall at the circumferential necking region 1814 of FIG. 18A. FIG. 19 is a longitudinal sectional view of an alternative narrowed ring mandrel 1912 with a circumferential reduced wall thickness 1914. The longitudinal axis 1916 of the mandrel 1912 shown in FIG. 19 may also correspond to the services conduit 328.

FIG. 20 is also a longitudinal sectional view of another ring mandrel wall as an alternative or an addition. In FIG. 20 the circumferential portion 2014 has an increased diameter compared with the rest of the alternate ring mandrel 2012.

It will be readily appreciated that use of the above recessing, necking, diameter increases or similar may aid in mechanically decoupling the displacements to non-circular shaping at the second end from the rigid first end attached to the extrusion head. In addition the choice of the decoupling or isolation forms may be done to suit appropriate melt flow through the extrusion head.

The circumferential portion forming the decoupling as described above also may have a smooth and continuous surface as described above from the first end to the second end of the ring mandrel. In addition the wall composition and/or material properties locally at the circumferential portion may also be varied to aid in improving the shape forming of the second end.

The length of the ring mandrel from the isolating circumferential portion to the second end/die exit may also be increased or varied to further improve or vary the shape forming at the die exit with the second end. In addition an aspect ratio of a diameter of the ring mandrel to a length of the ring mandrel may also be varied in order to improve the flexibility and resilience of the second end. Other aspect ratios to a diameter of the second end to a diameter of the circumferential portion or a wall thickness ratio between the circumferential portion and towards the second end may also be varied. In addition other aspect ratios may be formulated or conceived for the ring mandrel with respect to the die gap and the die exit.

In one example of a modified circumferential portion 1814, 1914, 2014 the ring mandrel may have the following characteristics. A medium carbon steel with some corrosive resistance such as 4140 may be used to fabricate an approximately 10 mm thick or more wall of the ring mandrel. The ring mandrel may have an overall length 540 mm from the first end 114 to the second end 120 and a second end outer diameter (o.d.) of 540 mm. Such a ring mandrel may be used within an extrusion head with a die exit of approximately 780 mm internal diameter for extruding large diameter polyethylene pipe. The ring mandrel may have a recessed or necked circumferential portion of o.d. 465 mm located approximately 217 mm from the first end 114 which is attached to the extrusion head. Accordingly aspect ratios of length (L) to diameter (D), L/D, for the example, ring mandrel may be 1.0. Other suitable aspect ratios for L/D may be in the approximate range of 0.7 to 0.9. Other aspect ratios may be selected for L/D depending on the material used for the ring mandrel wall and the flexing means actuators and arrangement, for example.

The displacements to the second end by the flexing means may be approximately 16 mm for a mounting at the second end or a corresponding 32 mm change to the overall diameter. That is nominal diameter for the horizontal axis may be increased by up to 32 mm with the nominal diameter for the vertical axis may be decreased by up to 32 mm in order to provide an oval or elliptical shape to the second end of the ring mandrel at the die exit.

FIG. 21 is a schematic in longitudinal cross-sectional view of a shaft actuated flexing means 2122 alternative. A pair of opposed shanks 2124 are suitably, pivotally attached to opposed first mountings 2126 that are attached or otherwise secured to the rim 124 or inner surface towards the second end 120 of the ring mandrel. The other ends of the opposed shanks 2124 are also pivotally connected with an actuating shaft 2128 that may extend into the services conduit 328 of the extrusion head 314. As shown in FIG. 21 the arrangement of the opposed shanks 2124, first mountings 2126 and shaft 2128 are such that the opposed shanks are inclined in the opposite direction to the actuation of the shaft 2128 into the extrusion head. When the shaft 2128 is moved or pulled in the direction of arrow 2130 the opposed shanks 2124 push against the first mountings 2126 so as to displace the rim 124 and the second end wall outwards in the direction of arrow 2132.

The oversized lengths of the opposed shanks in comparison to the diameter of the second end 120 may be designed to provide a suitable mechanical advantage for the mechanism used to actuate the shaft 2128 into the extrusion head and consequently displace the first mountings 2126 outwards into the die gap.

FIG. 22 is a schematic in longitudinal cross-sectional view of a corresponding, independent shaft actuated flexing means 2222 to inwardly displace the second end wall at second mountings 2226. Alternatively to FIG. 21 the further shanks 2226 of the corresponding flexing means 2222 are inclined in the direction of the actuation 2230 or neutrally inclined as shown in FIG. 22. The amount of inclination may be designed to provide the appropriate level of mechanical advantage for actuation. In use when the second actuating shaft 2230 is moved in the direction of the arrow 2230 the further opposed shanks pull together the second mountings such that the rim 124 and second end wall portion inwardly displace to increase the die gap.

It will be readily appreciated that a single actuating shaft may be used to combine the actions described above with respect to FIGS. 21 and 22 if independent actuation control is not required. For example the opposed shanks 2124 and further shanks 2224 may be suitably connected to the same shaft for actuation. It will be also readily appreciated that asymmetric shapes to the second end may be formed by varying the lengths of the shanks 2124, 2224 and/or the positioning of the actuating shaft as well as the other techniques described herein for asymmetric shape forming.

In another alternative for asymmetric shape forming at the die exit: a mounting to the rim 124 may be anchored to the extrusion head independently for example through the mounting plate 216. The opposing mounting may then be actuated to be inwardly or outwardly displaced as desired using the techniques and methods described herein. The anchored mounting option may be used to aid in forming flat topped asymmetric shapes for a ring mandrel.

In this specification, terms denoting direction, such as vertical, up, down, left, right etc. or rotation, should be taken to refer to the directions or rotations relative to the corresponding drawing rather than to absolute directions or rotations unless the context require otherwise.

Although the invention has been herein shown and described in what is conceived to be the most practical and preferred embodiments, it is recognized that departures can be made within the scope of the invention, which are not to be limited to the details described herein but are to be accorded the full scope of the appended claims so as to embrace any and all equivalent assemblies, devices, apparatus, articles, compositions, methods, processes and techniques.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise, comprised and comprises” where they appear.

1. A flexible die head for extruding pipe comprising:
a die gap defined by a mandrel and a die, and
means for flexing at least one of the mandrel and the die;
wherein a base of the flexible die head is constrained to a fixed shape; and
wherein at least one of the mandrel and the die provides within the die gap a continuous surface for forming a corresponding surface of the extruding pipe.

2. A flexible die head according to claim 1, wherein the mandrel is a flexible ring mandrel.

3. A flexible die head according to claim 2, wherein the flexible ring mandrel comprises:
a ring constrained at a first end to a constant shape,
a second, opposing end of the ring forming a portion of a die exit, and
a wall of the ring between the first end and the second end.

4. A flexible die head according to claim 3, wherein the means for flexing is located within the flexible ring mandrel and is attached to an inner surface of the wall of the flexible ring mandrel.

5. A flexible die head according to claim 3, wherein the means for flexing is attached to a rim of the wall and the rim is located proximate the die exit.

6. A flexible die head according to claim 4, wherein the means for flexing deforms the ring mandrel at the die exit to a non-circular shape.

7. A flexible die head according to claim 5, wherein the non-circular shape is at least one of a symmetric ellipse, an asymmetric ellipse, an ovoid, a Cassini oval, a flattened section or chord section of a non-circular shape and an oval.

8. A flexible die head according to claim 3, wherein the means for flexing includes an actuator attached to two opposed first mountings to the second end of the ring mandrel.

9. A flexible die head according to claim 8, further including a quadrilateral arrangement of rods interconnected pivotally at the respective rod ends,
wherein a first opposed pivoting rod ends of the quadrilateral are pivotally attached to the first opposed mountings of the ring mandrel, and
the second opposed pivoting rod ends of the quadrilateral arrangement are pivotally attached to two further opposed second mountings.

10. A flexible die head according to claim 9, wherein when the actuator extends, the first mountings are outwardly radially displaced and the second mountings are caused to inwardly radially displace; thereby deforming the ring mandrel at the die exit to a non-circular shape.

11. A flexible die head according to claim 2, wherein the means for flexing comprises:
a first shaft coaxial to the longitudinal axis of the ring mandrel; and
a pair of opposed shanks, the proximate ends of each shank being pivotally connected to the first shaft and the distal ends of each shank being pivotally connected to two opposed first mountings to the second end of the ring mandrel;
wherein the respective proximate end and distal end of each shank are respectively longitudinally offset when pivotably connected to the opposed first mountings and the first shaft such that actuating the first shaft causes the first mountings to outwardly radially displace, thereby deforming the ring mandrel at the die exit to a non-circular shape.

12. A flexible die head according to claim 11, wherein the means for flexing further includes:
a second shaft coaxial to the longitudinal axis of the ring mandrel; and
a further pair of opposed shanks, the proximate ends of each further shank being pivotally connected to the second shaft and the distal ends of each further shank being pivotally connected to two opposed second mountings to the second end of the ring mandrel;
wherein the respective proximate end and distal end of each further shank are respectively longitudinally offset when pivotably connected to the second mounting and the second shaft such that actuating the second shaft causes the second mountings to inwardly radially displace.

13. A flexible die head according to claim 8, wherein the first and second mountings are respectively diametrically opposed and spaced equidistant about the second end of the ring mandrel such that when the means for flexing is actuated a symmetric non-circular shape is formed.

14. A flexible die head according to claim 13, wherein the symmetric non-circular shape of the second end of the ring mandrel includes at least one of a symmetric ellipse, a Cassini oval and an oval.

15. A flexible die head according to claim 8, wherein the first and second mountings are respectively spaced about the second end of the ring mandrel such that when the means for flexing is actuated an asymmetric non-circular shape is formed by the second end of the ring mandrel.

16. A flexible die head according to claim 15, wherein the asymmetric non-circular shape of the second end of the ring mandrel includes at least one of an asymmetric ellipse, an ovoid and a flattened section or chord section of a non-circular shape.

17. A flexible die head according to claim 3, wherein the continuous surface includes an outer surface of the wall of the ring.

18. A flexible die head according to claim 17, wherein the outer surface of the wall is continuous from the first end to the second end of the ring mandrel and circumferentially about the ring mandrel.

19. A flexible die head according to claim 5, wherein the continuous surface further includes the portion of the outer surface of the wall extending from the rim to the first end.

20. A flexible die head according to claim 3, wherein a circumferential portion of the ring mandrel towards the first end is recessed, thereby increasing a flexibility of the second end of the ring mandrel.

21. A flexible die head according to claim 20, wherein the recess is a reduction in a diameter of the circumferential portion of the ring mandrel compared with a diameter of the ring mandrel towards the second end.

22. A flexible die head according to claim 20, wherein the recess is a reduced wall thickness in the circumferential portion compared with a wall thickness in another portion of the ring mandrel towards the second end of the ring mandrel.

23. A flexible die head according to claim 3, wherein a circumferential portion of the ring mandrel towards the first end is increased in a diameter compared with a diameter of the ring mandrel towards the second end, thereby increasing a flexibility of the second end of the ring mandrel.

24. (canceled)

25. A flexible die head according to claim 3, wherein a material for the wall of the ring is sufficiently elastic and sufficiently rigid for forming the extruding pipe.

26. A flexible die head according to claim 3, wherein the wall of the ring is formed from concentric, adjacent cylinders.

27. A flexible die head according to claim 26, wherein the number of concentric cylinders is in the approximate range of 2 to 8.

28. (canceled)

29. A flexible die head according to claim 26, wherein the concentric cylinders are secured together at a first end of the ring mandrel.

30. A flexible die head according to claim 26, wherein the second opposed mounting is secured to all the concentric cylinders.

31. A flexible die head according to claim 26, wherein the concentric cylinder material is steel.

32. A flexible die head according to claim 25, wherein the material is a composite of at least two of a metal, a carbon fibre, a Kevlar fibre and a resin.

33.-35. (canceled)

36. A flexible die head according to claim 1, wherein a wall thickness of the extruding pipe is approximately between 50 and 180 mm.

37. A flexible die head according to claim 1, wherein at least a portion of the material of the extruding pipe is at least one of a plastic, a polyolefin, a polyalkene, a thermoplastic, an extrudable plastic and a polyethylene.

38.-50. (canceled)
